(19) United States
(12) Patent Application Publication
(10) Pub. No.: US 2012/0247763 A1
(43) Pub. Date: Oct. 4, 2012

(54) BIOMASS-BASED OIL FIELD CHEMICALS

(75) Inventors: Walter Rakitsky, San Diego, CA (US); Sonia Sousa, San Francisco, CA (US); Anthony G. Day, San Francisco, CA (US)

(73) Assignee: SOLAZYME, INC., SOUTH SAN FRANCISCO, CA (US)

(21) Appl. No.: 13/436,543

(22) Filed: Mar. 30, 2012

Related U.S. Application Data
(60) Provisional application No. 61/471,013, filed on Apr. 1, 2011.
(60) Provisional application No. 61/609,214, filed on Mar. 9, 2012.

(51) Int. Cl. C09K 8/00; E21B 43/00; C09K 8/42; E21B 7/00; C09K 8/035; C09K 8/62

(52) U.S. Cl. 166/279; 507/101; 507/201; 175/57; 166/369

(57) ABSTRACT

Microbial biomass from oleaginous microbes provides a cost-efficient, biodegradable additive for use in well-related fluids. The biomass is useful as a fluid loss control agent, viscosity modifier, emulsifier, lubricant, or density modifier.

### CROSS-REFERENCE TO RELATED APPLICATIONS

This application claims the benefit of U.S. provisional application No. 61/471,013, filed Apr. 1, 2011, and U.S. provisional application No. 61/609,214, filed Mar. 9, 2012, which are hereby incorporated by reference in their entireties.

### BACKGROUND OF THE INVENTION

1. Field of the Invention

The present invention provides microbial biomass-based ingredients for fluid a loss control agent, bridging material, viscosity modifying agent, and other uses that are useful in drilling fluids, servicing fluids, completion fluids, cementing fluids, reservoir fluids, and other fluids used in drilling applications. The microbial biomass-based materials, useful as fluid loss control agents, bridging materials, viscosity modifying agents relate to the fields of oil and gas exploration, geothermal wells, water wells and other applications in which a borehole is drilled into the earth.

2. Background

Drilling fluid (sometimes referred to in the art as “drilling mud”) is a fluid used in connection with drilling boreholes. While typically used in drilling oil and natural gas wells, drilling fluids are used in other applications, including drilling water and geothermal wells. The three main categories of drilling fluids are water-based muds (which can be dispersed and non-dispersed), non-aqueous muds (sometimes referred to as “oil-based mud”), and gaseous drilling fluids. While drilling, there are several problems that need to be contended with including keeping the drill bit cool and clean, formation fluids (i.e., fluids such as oil present in the formation being drilled) entering the well bore, and suspending and removing the drill cuttings. Because of these problems, drilling fluid needs to have a combination of the correct viscosity and flowability. The drilling fluid needs to be viscous enough to prevent formation fluids from entering the well bore and to suspend the drill cuttings. Certain drilling fluids also carry out or remove the suspended drill cuttings.

During the drilling of an oil well, filtrate from the drilling fluid may be forced into the adjacent subterranean formation (“invasion”). This can damage the formation; for example, some zones contain clays that, when hydrated by the drilling fluid, tend to block movement of oil and gas into the borehole. To prevent or reduce such damage, fluid loss control agents are used to control filtration rates of aqueous drilling fluids and act to seal the pores in the formation by forming a filter cake. Material used for sealing the filter cake (or “wall cake”) pores have included materials such as starches, modified starches, cellulose, modified cellulose, synthetic polymers, such as polyacrylates, polyacrylamides, and lignites (see U.S. Pat. No. 5,789,349, incorporated herein by reference).

Invasion is caused by the differential pressure of the hydrostatic column which is generally greater than the formation pressure, especially in low pressure or depleted zones. Invasion is also due to the openings in the rock and the ability of fluids to move through the rock, the porosity and permeability of the zone. More recent technology utilizes Low Shear Rate Viscosity (LSRV) fluids created by the addition of specialized polymers to water or brines to form a drilling fluid. These polymers create extremely high viscosity at very low shear rates. LSRV help control the invasion of drilling fluids and filtrate by creating a high resistance to movement into the formation openings. Because the fluid moves at a very slow rate, viscosity becomes high, and the drilling fluid is contained within the borehole with slight penetration. See “Drill-In Fluids Improve High Angle Well Production”, Supplement to the Petroleum Engineer International, March, 1995.

Lost circulation, however, still remains a problem. Lost circulation occurs when the differential pressure of the hydrostatic column is much greater than formation pressure. The openings in the rock accept and store drilling fluid so that less is returned to surface for recirculation. The fluid is lost downhole and can lead to hole instability, stuck drill pipe, and loss of well control. In addition to the fluid volume being lost, expensive lost circulation materials (LCM or “fluid loss control agents”) are required. These are usually fibrous, granular, or flake materials such as cane fibers, wood fibers, cottonseed hulls, nut hulls, mica, cellophane, and other materials. These LCM materials are added to the fluid system so that they may be carried into the loss zone and lodge to form a bridge on which other materials may begin to build and seal (see U.S. Pat. No. 6,770,601, incorporated herein by reference).

In addition to fluids used in drilling, various fluids are also used in extraction of natural resources such as oil and natural gas from the well. These fluids can function to inhibit corrosion, separate hydrocarbons from water, inhibit the formation of inhibitory solids such as paraffin, scale, and metal oxides, and to enhance production from the well. Fluids may also be used in cementing, hydraulic fracturing, and acidifying.

### SUMMARY OF THE INVENTION

The invention provides, in certain embodiments, a fluid for use in the creation or maintenance of, or production from, a borehole or well, wherein the fluid includes biomass from an oleaginous microbe. In particular embodiments, the biomass functions as a bridging agent, a fluid loss control agent, a viscosity modifier, an emulsifier, a lubricant, and/or a density modifier. In some embodiments, the fluid includes an aqueous or non-aqueous solvent and optionally includes one or more additional components so that the fluid is operable as a drilling fluid, a drill-in fluid, a workover fluid, a spotting fluid, a cementing fluid, a reservoir fluid, a production fluid, a hydraulic fracturing fluid, or a completion fluid. The biomass in the fluid can be from oleaginous microbes such as, for example, microalgae, yeast, fungi, or bacteria. The microbial biomass can include, e.g, intact cells, lysed cells, a combination of intact and lysed cells, cells from which oil has been removed, and/or polysaccharide from the oleaginous microbe. In certain embodiments, the microbial biomass is chemically modified. Illustrative chemical modifications include covalent attachment of hydrophobic, hydrophilic, anionic, and cationic moieties. In particular embodiments, the microbial biomass is chemically modified through one or more chemical reactions selected from transesterification, saponification, crosslinking, anionization (e.g., carboxymethylation), acetylation, and hydrolysis. The microbial biomass can, in certain embodiments, be approximately 0.1% to approximately 20% by weight of the fluid.

In various embodiments, the fluid includes one or more further additives selected from bentonite, xanthan gum, guar gum, starch, carboxymethylcellulose, hydroxyethyl cellulose, polyanionic cellulose, biocide, a pH adjusting agent, an oxygen scavenger, a foamer, a demulsifier, a corrosion inhibitor, a clay control agent, a dispersant, a flocculant, a friction reducer, a bridging agent, a lubricant, a viscosifier, a salt, a surfactant, an acid, a fluid loss control additive, a gas, an emulsifier, a density modifier, diesel fuel, and an aphron. For example, the fluid can include an aphron having an average diameter of 5 to 50 micrometers at a concentration of about 0.001% to 5% by mass of the fluid.

In particular embodiments, the biomass results from one or more of drying, pressing, and solvent-extracting oil from the oleaginous microbe. The biomass can, in certain embodiments, be produced by the heterotrophic growth of the oleaginous microbe including, for example, heterotrophic growth of an obligate heterotroph, such as Prototheca moriformis.

In certain embodiments, fluids including the oleaginous microbial biomass described above have a decreased API Fluid loss test, as compared to fluids lacking the oleaginous microbial biomass. Illustrative fluids can have a reduction in fluid loss of greater than 2-, 5-, or 10-fold, relative to a control fluid lacking oleaginous microbial biomass, according to the API Fluid Loss test for a duration of either 7.5 or 30 minutes. In particular embodiments, fluids including the oleaginous microbial biomass can have 2-fold, 5-fold, 10-fold or greater increase in yield point, relative to a control fluid lacking oleaginous microbial biomass, as measured using a Couette type viscometer. In some embodiments, fluids including the oleaginous microbial biomass can have an at least 2-fold decrease in spurt loss volume, relative to a control fluid lacking oleaginous microbial biomass, as measured according to a static fluid loss test performed with a ceramic disc filter. In particular embodiments, fluids including the oleaginous microbial biomass can have an at least 2-fold decrease in total fluid loss volume, relative to a control fluid lacking oleaginous microbial biomass as measured according to a static fluid loss test performed with a ceramic disc. In either case, illustrative ceramic discs can have a pore size of 5 microns, 10 microns, or 20 microns. In certain embodiments, the decrease in spurt loss volume or total fluid loss volume is measured in the static fluid loss test after a duration of 30 minutes or 60 minutes. In certain embodiments, fluids including the oleaginous microbial biomass can have an at least 2-fold increase in gel strength, relative to a control fluid lacking this biomass, according to a gel strength test performed with a Couette type viscometer. In particular embodiments, the gel strength test is performed for a duration of 7.5 minutes or 30 minutes. In some embodiments, fluids including the oleaginous microbial biomass can have a higher calculated viscosity after aging at a temperature of between 18° C. and 200° C. for at least 16 hours, than prior to aging, when measured at a shear rate between 0.01/sec and 1000/sec.

The invention also provides, in certain embodiments, a method for creating a wellbore, or maintaining, or producing a production fluid from a well, wherein the method entails introducing any of the above-described fluids. In particular embodiments, the method entails using the fluid to for a well servicing operation selected from completion operations, sand control operations, workover operations, and hydraulic fracturing operations. In some embodiments, the method entails drilling a wellbore through a formation by operating a drilling assembly to drill a wellbore while circulating a drilling fluid through the wellbore. In variations of these embodiments, the biomass achieves one or more of the following effects: occludes pores in the wellbore or well, provides lubrication to a drill bit of the drilling assembly, and/or increases the viscosity of the fluid.

In certain embodiments, the invention further provides a method for stimulating the production of methane from methanogenic microbes in a well. This method entails introducing biomass into the well, wherein the biomass is produced by cultivating an oleaginous microbe.

In an additional aspect, the present invention provides a microbial biomass-based fluid loss control agent, bridging material, and viscosity modifying agent. The microbial biomass is from an oleaginous microbe that has been cultured under conditions, such as heterotrophic conditions, that lead to high oil content. In some embodiments, the microbial biomass retains substantial oil, or the microbial biomass is used prior to removal of the oil (unextracted microbial biomass). In some embodiments, the microbial biomass is “spent biomass”, which is the remaining after processing that removes some substantial portion of the oil. In additional embodiments, the microbial biomass is oil or fatty acid derivatives produced by an oleaginous microbe. In some embodiments, the biomass is biomass that has been chemically modified, e.g., processed by one or more processes including drying, heating, flaking, grinding, acetylation, anionization, crosslinking, or carbonization to provide the microbial biomass-based fluid loss control agent of the invention. In various embodiments, the oleaginous microbe is an oleaginous bacteria, microalga, yeast, or non-yeast fungus.

In an additional aspect, the present invention provides a drilling fluid comprising the fluid loss control agent of the invention. In various embodiments, the drilling fluid comprises from about 0.1% to about 20% (w/w or v/v) of said fluid loss control agent. In one embodiment, the drilling fluid is an aqueous drilling fluid that comprises a viscosifier. In another embodiment, the drilling fluid is a non-aqueous drilling fluid that comprises a viscosifier. In various embodiments, the viscosifier is selected from the group consisting of alginate polymer(s), xanthan gum(s), cellulose or cellulose derivatives, biopolymers, bentonitic clay(s). In one embodiment, the drilling fluid is an aqueous drilling fluid that comprises a lubricant. In another embodiment, the drilling fluid is a non-aqueous drilling fluid that comprises a lubricant. In various embodiments, the drilling fluid has a low shear rate viscosity as measured with a Brookfield viscometer at 0.5 rpm of at least 20,000 centipoise.

In a further aspect, the present invention provides methods of making the fluid loss control agent and drilling fluids of the invention, said methods comprising culturing an oleaginous microbe under conditions leading to the accumulation of at least 10% (w/w) oil. In one embodiment, the drilling fluid of the invention is made by adding the microbial biomass-based fluid loss control agent to a drilling fluid. In various embodiments, the drilling fluid is a conventional drilling fluid in which one or more fluid loss control agents is partially or totally replaced by the microbial biomass-based fluid loss control agent of the invention.

In yet another aspect, the present invention provides methods of drilling a wellbore, said methods comprising the step of using a fluid loss control agent or drilling fluid of the invention.

### DETAILED DESCRIPTION OF THE INVENTION

The present invention provides fluid loss control agents and drilling fluids. To aid in understanding the invention, and how the invention is made and practiced, as well as the benefits thereof, this detailed description is divided into sections. Section I provides helpful definitions. Section II provides oleaginous microbes useful in the methods of the invention as well as methods for culturing them under heterotrophic conditions. Section III provides methods for preparing spent biomass suitable for use as a fluid loss control agent of the invention. Section IV provides a description of the drilling fluids of the invention and methods for using them in drilling boreholes. Following Section IV, illustrative examples of making and using various aspects and embodiments of the invention are provided.

### I. Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

“Aphron” is a microbubble comprising one or more surfactant layers surrounding a gaseous or liquid core.

“Axenic” is a culture of an organism free from contamination by other living organisms.

“Biodiesel” is a biologically produced fatty acid alkyl ester suitable for use as a fuel in a diesel engine.

“Biomass” is material produced by growth and/or propagation of cells. Biomass may contain cells and/or intracellular contents as well as extracellular material, includes, but is not limited to, compounds secreted by a cell.

“Bridging material” is material added to a fluid that prevents or decreases loss of the fluid through geologic formations that have pores that are greater than 1 millidarcy.

“Bioreactor” and “fermentor” mean an enclosure or partial enclosure, such as a fermentation tank or vessel, in which cells are cultured, typically in suspension.

“Cellulosic material” includes the product of digestion of cellulose, including glucose and xylose, and optionally additional compounds such as disaccharides, oligosaccharides, lignin, furfurals and other compounds. Nonlimiting examples of sources of cellulosic material include sugar cane bagasses, sugar beet pulp, corn stover, wood chips, sawdust and switchgrass.

“Cultivated”, and variants thereof such as “cultured” and “fermented”, refer to the intentional fostering of growth (increases in cell size, cellular contents, and/or cellular activity) and/or propagation (increases in cell numbers via mitosis) of one or more cells by use of selected and/or controlled conditions. The combination of both growth and propagation is termed proliferation. Examples of selected and/or controlled conditions include the use of a defined medium (with known characteristics such as pH, ionic strength, and carbon source), specified temperature, oxygen tension, carbon dioxide levels, and growth in a bioreactor. Cultivate does not refer to the growth or propagation of microorganisms in nature or otherwise without human intervention; for example, natural growth of an organism that ultimately becomes fossilized to produce geological crude oil is not cultivation.

“Cytolysis” is the lysis of cells in a hypotonic environment. Cytolysis is caused by excessive osmosis, or movement of water, towards the inside of a cell (hyperhydration). If the cell cannot withstand the osmotic pressure of the water inside, it bursts.

“Dry weight” and “dry cell weight” mean weight determined in the relative absence of water. For example, reference to oleaginous yeast biomass as comprising a specified percentage of a particular component by dry weight means that the percentage is calculated based on the weight of the biomass after substantially all water has been removed.

“Exogenous gene” is a nucleic acid that codes for the expression of an RNA and/or protein that has been introduced (“transformed”) into a cell. A transformed cell may be referred to as a recombinant cell, into which additional exogenous gene(s) may be introduced. The exogenous gene may be from a different species (and so heterologous), or from the same species (and so homologous), relative to the cell being transformed. Thus, an exogenous gene can include a homologous gene that occupies a different location in the genome of the cell or is under different control, relative to the endogenous copy of the gene. An exogenous gene may be present in more than one copy in the cell. An exogenous gene may be maintained in a cell as an insertion into the genome or as an episomal molecule.

“Exogenously provided” refers to a molecule provided to the culture media of a cell culture.

“Expeller pressing” is a mechanical method for extracting oil from raw materials such as soybeans and rapeseed. An expeller press is a screw type machine, which presses material through a caged barrel-like cavity. Raw materials enter one side of the press and spent cake exits the other side while oil seeps out between the bars in the cage and is collected. The machine uses friction and continuous pressure from the screw drives to move and compress the raw material. The oil seeps through small openings that do not allow solids to pass through. As the raw material is pressed, friction typically causes it to heat up.

“Fixed carbon source” is a molecule(s) containing carbon, typically an organic molecule, that is present at ambient temperature and pressure in solid or liquid form in a culture media that can be utilized by a microorganism cultured therein.

“Fluid loss control agent” is material added to a fluid that prevents or decreases loss of the liquid component of the fluid through geologic formations that have pores that are less than 1 millidarcy.

“Growth” means an increase in cell size, total cellular contents, and/or cell mass or weight of an individual cell, including increases in cell weight due to conversion of a fixed carbon source into intracellular oil.

“Homogenate” is biomass that has been physically disrupted.

“Hydrocarbon” is (a) a molecule containing only hydrogen and carbon atoms wherein the carbon atoms are covalently linked to form a linear, branched, cyclic, or partially cyclic backbone to which the hydrogen atoms are attached. The molecular structure of hydrocarbon compounds varies from the simplest, in the form of methane (CH₄), which is a constituent of natural gas, to the very heavy and very complex, such as some molecules such as asphaltenes found in crude oil, petroleum, and bitumens. Hydrocarbons may be in gaseous, liquid, or solid form, or any combination of these forms, and may have one or more double or triple bonds between adjacent carbon atoms in the backbone. Accordingly, the term includes linear, branched, cyclic, or partially cyclic alkanes, alkenes, lipids, and paraffin. Examples include propane, butane, pentane, hexane, octane, and squalene.

“Limiting concentration of a nutrient” is a concentration of a compound in a culture that limits the propagation of a cultured organism. A “non-limiting concentration of a nutrient” is a concentration that supports maximal propagation during a given culture period. Thus, the number of cells produced during a given culture period is lower in the presence of a limiting concentration of a nutrient than when the nutrient is non-limiting. A nutrient is said to be “in excess” in a culture, when the nutrient is present at a concentration greater than that which supports maximal propagation.

“Lipids” are a class of molecules that are soluble in nonpolar solvents (such as ether and chloroform) and are relatively or completely insoluble in water. Lipid molecules have these properties, because they consist largely of long hydrocarbon chains which are hydrophobic in nature. Examples of lipids include fatty acids (saturated and unsaturated); glycerides or glycerolipids (such as monoglycerides, diglycerides, triglycerides or neutral fats, and phosphoglycerides or glycerophospholipids); nonglycerides (sphingolipids, sterol lipids including cholesterol and steroid hormones, prenol lipids including terpenoids, fatty alcohols, waxes, and polyketides); and complex lipid derivatives (sugar-linked lipids, or glycolipids, and protein-linked lipids). “Fats” are a subgroup of lipids called “triacylglycerides.”

“Lysate” is a solution containing the contents of lysed cells.

“Lysis” is the breakage of the plasma membrane and optionally the cell wall of a biological organism sufficient to release at least some intracellular content, often by mechanical, viral or osmotic mechanisms that compromise its integrity.

“Lysing” is disrupting the cellular membrane and optionally the cell wall of a biological organism or cell sufficient to release at least some intracellular content.

“Microorganism” and “microbe” are microscopic unicellular organisms.

“Oil” means any triacylglyceride (or triglyceride oil), produced by organisms, including oleaginous yeast, plants, and/or animals. “Oil,” as distinguished from “fat”, refers, unless otherwise indicated, to lipids that are generally liquid at ordinary room temperatures and pressures. For example, “oil” includes vegetable or seed oils derived from plants, including without limitation, an oil derived from soy, rapeseed, canola, palm, palm kernel, coconut, corn, olive, sunflower, cotton seed, cuphea, peanut, camelina sativa, mustard seed, cashew nut, oats, lupine, kenaf, calendula, hemp, coffee, linseed, hazelnut, euphorbia, pumpkin seed, coriander, camellia, sesame, safflower, rice, tung oil tree, cocoa, copra, pium poppy, castor beans, pecan, jojoba, jatropha, macadamia, Brazil nuts, and avocado, as well as combinations thereof.

“Oleaginous yeast” means yeast that can naturally accumulate more than 20% of their dry cell weight as lipid and are of the Dikarya subkingdom of fungi. Oleaginous yeast includes organisms such as Yarrowia lipolytica, Rhodotorula glutinis, Cryptococcus curvatus and Lipomyces starkeyi.

“Osmotic shock” is the rupture of cells in a solution following a sudden reduction in osmotic pressure. Osmotic shock is sometimes induced to release cellular components of such cells into a solution.

“Polysaccharides” or “glycans” are carbohydrates made up of monosaccharides joined together by glycosidic linkages. Cellulose is a polysaccharide that makes up certain plant cell walls. Cellulose can be depolymerized by enzymes to yield monosaccharides such as xylose and glucose, as well as larger disaccharides and oligosaccharides.

“Predominantly encapsulated” means that more than 50% and typically more than 75% to 90% of a referenced component, e.g., algal oil, is sequestered in an oleaginous microbe cell or cells.

“Predominantly intact cells” and “predominantly intact biomass” mean a population of cells that comprise more than 50, and often more than 75, 90, and 98% intact cells. “Intact”, in this context, means that the physical continuity of the cellular membrane and/or cell wall enclosing the intracellular components of the cell has not been disrupted in any manner that would release the intracellular components of the cell to an extent that exceeds the permeability of the cellular membrane in culture.

“Predominantly lysed” means a population of cells in which more than 50%, and typically more than 75 to 90%, of the cells have been disrupted such that the intracellular components of the cell are no longer completely enclosed within the cell membrane.

“Proliferation” means a combination of both growth and propagation.

“Propagation” means an increase in cell number via mitosis or other cell division.

“Renewable diesel” is a mixture of alkanes (such as C10:0, C12:0, C14:0, C16:0 and C18:0) produced through hydrogenation and deoxygenation of lipids.

“Spent biomass” and variants thereof such as “delipidated meal” and “defatted biomass” is microbial biomass after oil (including lipids) and/or other components have been extracted or isolated from it, either through the use of mechanical (i.e., exerted by an expeller press) or solvent extraction or both. Such delipidated meal has a reduced amount of oil/lipids as compared to before the extraction or isolation of oil/lipids from the microbial biomass but typically contains some residual oil/lipid.

“Sonication” is a process of disrupting biological materials, such as a cell, by use of sound wave energy.

“Viscosity modifying agent” is an agent that modifies the rheological properties of a fluid. The viscosity of a fluid is the measure of the resistance of a fluid to flow. The viscosity modifying agent is used to increase or decrease the viscosity of a fluid used in oil field chemical applications

“V/V” or “v/v”, in reference to proportions by volume, means the ratio of the volume of one substance in a composition to the volume of the composition. For example, reference to a composition that comprises 5% v/v yeast oil means that 5% of the composition's volume is composed of oil (e.g., such a composition having a volume of 100 mm³ would contain 5 mm³ of oil), and the remainder of the volume of the composition (e.g., 95 mm³ in the example) is composed of other ingredients.

“W/V” or “w/v”, in reference to a concentration of a substance means grams of the substance per 100 mL of fluid.

“W/W” or “w/w”, in reference to proportions by weight, means the ratio of the weight of one substance in a composition to the weight of the composition. For example, reference to a composition that comprises 5% w/w oleaginous yeast biomass means that 5% of the composition's weight is composed of oleaginous yeast biomass (e.g., such a composition having a weight of 100 mg would contain 5 mg of oleaginous yeast biomass) and the remainder of the weight of the composition (e.g., 95 mg in the example) is composed of other ingredients.

### II. Oleaginous Microbes and Heterotrophic Culture Conditions

The biomass prepared from certain microorganisms that produce oil (“oleaginous microbes”) can be used in embodiments of the present invention, including as a fluid loss control agent. Suitable microorganisms include microalgae, oleaginous bacteria, and oleaginous yeast. Oleaginous microorganisms useful in the invention produce oil (lipids or hydrocarbons) suitable for fuel production or as feedstock for other industrial applications. Suitable lipids for fuel production include triacylglycerides (TAGs) containing long-chain fatty acid molecules. Suitable lipids or hydrocarbons for industrial applications, such as manufacturing, include fatty acids, aldehydes, alcohols, and alkanes.

Any species of organism that produces lipid or hydrocarbon can be used in the methods and drilling fluids of the invention, although microorganisms that naturally produce high levels of suitable lipid or hydrocarbon are preferred. Production of hydrocarbons by microorganisms is reviewed by Metzger et al., Appl Microbiol Biotechnol (2005) 66: 486-496 and A Look Back at the U.S. Department of Energy's Aquatic Species Program: Biodiesel from Algae, NREL/TP-580-24190, John Sheehan, Terri Dunahay, John Benemann and Paul Roessler (1998), incorporated herein by reference.

Considerations affecting the selection of a microorganism for use in generating microbial biomass for purposes of the invention include: (1) high lipid content as a percentage of cell weight; (2) ease of growth; and (3) ease of processing. In particular embodiments, the microorganism yields cells that are at least: about 40%, to 60% or more (including more than 70%) lipid when harvested for oil extraction. For many applications, organisms that grow heterotrophically (on sugar or a carbon source other than carbon dioxide in the absence of light) or can be engineered to do so, are useful in the methods and drilling fluids of the invention. See PCT Publication Nos. 2010/063031; 2010/063032; 2008/151149, each of which is incorporated herein by reference in their entireties.

Naturally occurring and genetically engineered microalgae are suitable microorganisms for use in preparing microbial biomass suitable for use in the methods and incorporation into the drilling fluids of the invention. Thus, in various embodiments of the present invention, the microorganism from which microbial biomass is obtained is a microalgae. Examples of genera and species of microalgae that can be used to generate microbial biomass in the methods and for incorporation into the drilling fluids of the present invention include, but are not limited to, the following genera and species microalgae.

TABLE 1
Microalgae.

Achnanthes orientalis, Agmenellum, Amphiprora hyaline, Amphora coffeiformis, Amphora
coffeiformis linea, Amphora coffeiformis punctata, Amphora coffeiformis taylori, Amphora
coffeiformis tenuis, Amphora delicatissima, Amphora delicatissima capitata, Amphora sp.,
Anabaena, Ankistrodesmus, Ankistrodesmus falcatus, Boekelovia hooglandii, Borodinella
sp., Botryococcus braunii, Botryococcus sudeticus, Bracteoccocus aerius, Bracteococcus
sp., Bracteacoccus grandis, Bracteacoccus cinnabarinas, Bracteococcus minor,
Bracteococcus medionucleatus, Carteria, Chaetoceros gracilis, Chaetoceros muelleri,
Chaetoceros muelleri subsalsum, Chaetoceros sp., Chlorella anitrata, Chlorella Antarctica,
Chlorella aureoviridis, Chlorella candida, Chlorella capsulate, Chlorella desiccate,
Chlorella ellipsoidea, Chlorella emersonii, Chlorella fusca, Chlorella fusca var. vacuolata,
Chlorella glucotropha, Chlorella infusionum, Chlorella infusionum var. actophila,
Chlorella infusionum var. auxenophila, Chlorella kessleri, Chlorella lobophora (strain SAG
37.88), Chlorella luteoviridis, Chlorella luteoviridis var. aureoviridis, Chlorella luteoviridis
var. lutescens, Chlorella miniata, Chlorella cf. minutissima, Chlorella minutissima,
Chlorella mutabilis, Chlorella nocturna, Chlorella ovalis, Chlorella parva, Chlorella
photophila, Chlorella pringsheimii, Chlorella protothecoides (including any of UTEX
strains 1806, 411, 264, 256, 255, 250, 249, 31, 29, 25), Chlorella protothecoides var.
acidicola, Chlorella regularis, Chlorella regularis var. minima, Chlorella regularis var.
umbricata, Chlorella reisiglii, Chlorella saccharophila, Chlorella saccharophila var.
ellipsoidea, Chlorella salina, Chlorella simplex, Chlorella sorokiniana, Chlorella sp.,
Chlorella sphaerica, Chlorella stigmatophora, Chlorella vanniellii, Chlorella vulgaris,
Chlorella vulgaris f. tertia, Chlorella vulgaris var. autotrophica, Chlorella vulgaris var.
viridis, Chlorella vulgaris var. vulgaris, Chlorella vulgaris var. vulgaris f. tertia, Chlorella
vulgaris var. vulgaris f. viridis, Chlorella xanthella, Chlorella zofingiensis, Chlorella
trebouxioides, Chlorella vulgaris, Chlorococcum infusionum, Chlorococcum sp.,
Chlorogonium, Chroomonas sp., Chrysosphaera sp., Cricosphaera sp., Crypthecodinium
cohnii, Cryptomonas sp., Cyclotella cryptica, Cyclotella meneghiniana, Cyclotella sp.,
Dunaliella sp., Dunaliella bardawil, Dunaliella bioculata, Dunaliella granulate, Dunaliella
maritime, Dunaliella minuta, Dunaliella parva, Dunaliella peircei, Dunaliella primolecta,
Dunaliella salina, Dunaliella terricola, Dunaliella tertiolecta, Dunaliella viridis,
Dunaliella tertiolecta, Eremosphaera viridis, Eremosphaera sp., Ellipsoidon sp., Euglena,
Franceia sp., Fragilaria crotonensis, Fragilaria sp., Gleocapsa sp., Gloeothamnion sp.,
Hymenomonas sp., Isochrysis aff. galbana, Isochrysis galbana, Lepocinclis, Micractinium,
Micractinium (UTEX LB 2614), Monoraphidium minutum, Monoraphidium sp.,
Nannochloris sp., Nannochloropsis salina, Nannochloropsis sp., Navicula acceptata,
Navicula biskanterae, Navicula pseudotenelloides, Navicula pelliculosa, Navicula
saprophila, Navicula sp., Neochloris oleabundans, Nephrochloris sp., Nephroselmis sp.,
Nitschia communis, Nitzschia alexandrina, Nitzschia communis, Nitzschia dissipata,
Nitzschia frustulum, Nitzschia hantzschiana, Nitzschia inconspicua, Nitzschia intermedia,
Nitzschia microcephala, Nitzschia pusilla, Nitzschia pusilla elliptica, Nitzschia pusilla
monoensis, Nitzschia quadrangular, Nitzschia sp., Ochromonas sp., Oocystis parva,
Oocystis pusilla, Oocystis sp., Oscillatoria limnetica, Oscillatoria sp., Oscillatoria
subbrevis, Parachlorella beijerinckii, Parachlorella kessleri, Pascheria acidophila,
Pavlova sp., Phagus, Phormidium, Platymonas sp., Pleurochrysis carterae, Pleurochrysis
dentate, Pleurochrysis sp., Prototheca stagnora, Prototheca portoricensis, Prototheca
moriformis, Prototheca wickerhamii, Prototheca zopfii, Pseudochlorella aquatica,
Pyramimonas sp., Pyrobotrys, Sarcinoid chrysophyte, Scenedesmus armatus, Scenedesmus
rubescens, Schizochytrium, Spirogyra, Spirulina platensis, Stichococcus sp., Synechococcus
sp., Tetraedron, Tetraselmis sp., Tetraselmis suecica, Thalassiosira weissflogii, and
Viridiella fridericiana.

The microorganisms can be genetically engineered to metabolize an alternative sugar source such as sucrose or xylose and/or produce an altered fatty acid profile. Where the microorganism can be grown heterotrophically, it can be an organism that is a permissive or obligate heterotroph. In a specific embodiment, the organism is Prototheca moriformis, an obligate heterotrophic oleaginous microalgae. In a further specific embodiment, the Prototheca moriformis, has been genetically engineered to metabolize sucrose or xylose.

In various embodiments of the present invention, the microorganism from which biomass is obtained is an organism of a species of the genus Chlorella. In various preferred embodiments, the microalgae is Chlorella protothecoides, Chlorella ellipsoidea, Chlorella minutissima, Chlorella zofinienesi, Chlorella luteoviridis, Chlorella kessleri, Chlorella sorokiniana, Chlorella fusca var. vacuolate Chlorella sp., Chlorella cf. minutissima or Chlorella emersonii. Chlorella is a genus of single-celled green algae, belonging to the phylum Chlorophyta. It is spherical in shape, about 2 to 10 μm in diameter, and is without flagella. Some species of Chlorella are naturally heterotrophic. Chlorella, particularly Chlorella protothecoides, is a preferred microorganism for use in generating biomass for purposes of the invention because of its high composition of lipid and its ability to grow heterotrophically.

Chlorella, for example, Chlorella protothecoides, Chlorella minutissima, or Chlorella emersonii, can be genetically engineered to express one or more heterologous genes (“transgenes”). Examples of expression of transgenes in, e.g., Chlorella, can be found in the literature (see for example PCT Patent Publication Nos. 2010/063031, 2010/063032, and 2008/151149; Current Microbiology Vol. 35 (1997), pp. 356-362; Sheng Wu Gong Cheng Xue Bao. 2000 July; 16(4):443-6; Current Microbiology Vol. 38 (1999), pp. 335-341; Appl Microbiol Biotechnol (2006) 72: 197-205; Marine Biotechnology 4, 63-73, 2002; Current Genetics 39:5, 365-370 (2001); Plant Cell Reports 18:9, 778-780, (1999); Biologia Plantarium 42(2): 209-216, (1999); Plant Pathol. J 21(1): 13-20, (2005)), and such references teach various methods and materials for introducing and expressing genes of interest in such organisms. Other lipid-producing microalgae can be engineered as well, including prokaryotic Microalgae (see Kalscheuer et al., Applied Microbiology and Biotechnology, Volume 52, Number 4/October, 1999), which are suitable for use to generate biomass in the methods and for incorporation into fluids in accordance with embodiments of the invention.

Prototheca is a genus of single-cell microalgae believed to be a non-photosynthetic mutant of Chlorella. While Chlorella can obtain its energy through photosynthesis, species of the genus Prototheca are obligate heterotrophs. Prototheca are spherical in shape, about 2 to 15 micrometers in diameter, and lack flagella. In various embodiments, the microalgae used to generate biomass in the methods and for incorporation into the drilling fluids of the invention is selected from the following species of Prototheca: Prototheca stagnora, Prototheca portoricensis, Prototheca moriformis, Prototheca wickerhamii and Prototheca zopfii.

In addition to Prototheca and Chlorella, other microalgae can be used to generate biomass for incorporation into the drilling fluids of the present invention. In various preferred embodiments, the microalgae is selected from a genus or species from any of the following genera and species: Parachlorella kessleri, Parachlorella beijerinckii, Neochloris oleabundans, Bracteacoccus grandis, Bracteacoccus cinnabarinas, Bracteococcus aerius, Bracteococcus sp. or Scenedesmus rebescens. Other non-limiting examples of microalgae (including Chlorella) are listed in Table 1, above.

In addition to microalgae, oleaginous yeast can accumulate more than 20% of their dry cell weight as lipid and so are useful to generate biomass for incorporation into the drilling fluids of the invention. In one preferred embodiment of the present invention, the microorganism from which microbial biomass is obtained is an oleaginous yeast. Examples of oleaginous yeast that can be used in the methods of the present invention to generate biomass suitable for incorporation into the drilling fluids of the invention include, but are not limited to, the oleaginous yeast listed in Table 2. Illustrative methods for the cultivation of oleaginous yeast (Yarrowia lipolytica and Rhodosporidium toruloides) in order to achieve high oil content and produce biomass for incorporation into the drilling fluids of the invention are provided in the examples below.

TABLE 2
Oleaginous Yeast.

Candida apicola, Candida sp., Cryptococcus curvatus, Cryptococcus
terricolus, Debaromyces hansenii, Endomycopsis vernalis, Geotrichum
carabidarum, Geotrichum cucujoidarum, Geotrichum histeridarum,
Geotrichum silvicola, Geotrichum vulgare, Hyphopichia burtonii,
Lipomyces lipofer, Lypomyces orentalis, Lipomyces starkeyi,
Lipomyces tetrasporous, Pichia mexicana, Rodosporidium
sphaerocarpum, Rhodosporidium toruloides, Rhodotorula aurantiaca,
Rhodotorula dairenensis, Rhodotorula diffluens, Rhodotorula glutinus,
Rhodotorula glutinis var. glutinis, Rhodotorula gracilis, Rhodotorula
graminis Rhodotorula minuta, Rhodotorula mucilaginosa, Rhodotorula
mucilaginosa var. mucilaginosa, Rhodotorula terpenoidalis,
Rhodotorula toruloides, Sporobolomyces alborubescens, Starmerella
bombicola, Torulaspora delbruekii, Torulaspora pretoriensis,
Trichosporon behrend, Trichosporon brassicae, Trichosporon
domesticum, Trichosporon laibachii, Trichosporon loubieri,
Trichosporon loubieri var. loubieri, Trichosporon montevideense,
Trichosporon pullulans, Trichosporon sp., Wickerhamomyces
Canadensis, Yarrowia lipolytica, and Zygoascus meyerae.

In one embodiment of the present invention, the microorganism from which biomass suitable for incorporation into the drilling fluids of the invention is obtained is a fungus. Examples of fungi that can be used in the methods of the present invention to generate biomass suitable for incorporation into the drilling fluids of the invention include, but are not limited to, the fungi listed in Table 3.

TABLE 3
Oleaginous Fungi.

Mortierella, Mortierrla vinacea, Mortierella alpine, Pythium debaryanum,
Mucor circinelloides, Aspergillus ochraceus, Aspergillus terreus,
Pennicillium iilacinum, Hensenulo, Chaetomium, Cladosporium,
Malbranchea, Rhizopus, and Pythium

Thus, in one embodiment of the present invention, the microorganism used for the production of microbial biomass for incorporation into the drilling fluids of the invention is a fungus. Examples of suitable fungi (e.g., Mortierella alpine, Mucor circinelloides, and Aspergillus ochraceus) include those that have been shown to be amenable to genetic manipulation, as described in the literature (see, for example, Microbiology, July; 153 (Pt. 7): 2013-25 (2007); Mol Genet Genomics, June; 271(5): 595-602 (2004); Curr Genet, March; 21(3):215-23 (1992); Current Microbiology, 30(2):83-86 (1995); Sakuradani, NISR Research Grant, “Studies of Metabolic Engineering of Useful Lipid-producing Microorganisms” (2004); and PCT/JP2004/012021).

In other embodiments of the present invention, a microorganism producing a lipid or a microorganism from which biomass suitable for use in the drilling fluids of the invention can be obtained is an oleaginous bacterium. Oleaginous bacteria are bacteria that can accumulate more than 20% of their dry cell weight as lipid. Species of oleaginous bacteria for use in the methods of the present invention, include species of the genus Rhodococcus, such as Rhodococcus opacus and Rhodococcus sp. Methods of cultivating oleaginous bacteria, such as Rhodococcus opacus, are known in the art (see Walternann, et al., (2000) Microbiology, 146: 1143-1149). Illustrative methods for cultivating Rhodococcus opacus to achieve high oil content and generate biomass suitable for use in the methods and drilling fluids of the invention are provided in the examples below.

To produce oil-containing microbial biomass suitable for use in the methods and compositions of the invention, microorganisms are cultured for production of oil (e.g., hydrocarbons, lipids, fatty acids, aldehydes, alcohols and alkanes). This type of culture is typically first conducted on a small scale and, initially, at least, under conditions in which the starting microorganism can grow. Culture for purposes of hydrocarbon production is preferentially conducted on a large scale and under heterotrophic conditions. Preferably, a fixed carbon source such as glucose or sucrose, for example, is present in excess. The culture can also be exposed to light some or all of the time, if desired or beneficial.

Microalgae and most other oleaginous microbes can be cultured in liquid media. The culture can be contained within a bioreactor. Optionally, the bioreactor does not allow light to enter. Alternatively, microalgae can be cultured in photobioreactors that contain a fixed carbon source and/or carbon dioxide and allow light to strike the cells. For microalgae cells that can utilize light as an energy source, exposure of those cells to light, even in the presence of a fixed carbon source that the cells transport and utilize (i.e., mixotrophic growth), nonetheless accelerates growth compared to culturing those cells in the dark. Culture condition parameters can be manipulated to optimize total oil production, the combination of hydrocarbon species produced, and/or production of a particular hydrocarbon species. In some instances, it is preferable to culture cells in the dark, such as, for example, when using extremely large (40,000 liter and higher) fermentors that do not allow light to strike a significant proportion (or any) of the culture.

Culture medium typically contains components such as a fixed nitrogen source, trace elements, optionally a buffer for pH maintenance, and phosphate. Components in addition to a fixed carbon source, such as acetate or glucose, may include salts such as sodium chloride, particularly for seawater microalgae. Examples of trace elements include zinc, boron, cobalt, copper, manganese, and molybdenum, in, for example, the respective forms of ZnCl₂, H₃BO₃, CoCl₂.6H₂O, CuCl₂.2H₂O, MnCl₂.4H₂O and (NH₄)₆Mo₇O₂₄.4H₂O. Other culture parameters can also be manipulated, such as the pH of the culture media, the identity and concentration of trace elements and other media constituents.

For organisms able to grow on a fixed carbon source, the fixed carbon source can be, for example, glucose, fructose, sucrose, galactose, xylose, mannose, rhamnose, N-acetylglucosamine, glycerol, floridoside, glucuronic acid, and/or acetate. The one or more exogenously provided fixed carbon source(s) can be supplied to the culture medium at a concentration of from at least about 50 μM to at least 500 mM, and at various amounts in that range (i.e., 100 μM, 500 μM, 5 mM, 50 mM).

Some microalgae species can grow by utilizing a fixed carbon source, such as glucose or acetate, in the absence of light. Such growth is known as heterotrophic growth. For Chlorella protothecoides, for example, heterotrophic growth can result in high production of biomass and accumulation of high lipid content. Thus, an alternative to photosynthetic growth and propagation of microorganisms is the use of heterotrophic growth and propagation of microorganisms, under conditions in which a fixed carbon source provides energy for growth and lipid accumulation. In some embodiments, the fixed carbon energy source comprises cellulosic material, including depolymerized cellulosic material, a 5-carbon sugar, or a 6-carbon sugar.

Methods for the growth and propagation of Chlorella protothecoides to high oil levels as a percentage of dry weight have been reported (see for example Miao and Wu, J. Biotechnology, 2004, 11:85-93 and Miao and Wu, Biosource Technology (2006) 97:841-846, reporting methods for obtaining 55% oil dry cell weight).

PCT Publication WO2008/151149, incorporated herein by reference, describes preferred growth conditions for microalgae such as Chlorella. Multiple species of Chlorella and multiple strains within a species can be grown in the presence of glycerol. The aforementioned patent application describes culture parameters incorporating the use of glycerol for fermentation of multiple genera of microalgae. Multiple Chlorella species and strains proliferate very well on not only purified reagent-grade glycerol, but also on acidulated and non-acidulated glycerol byproduct from biodiesel transesterification. In some instances, microalgae, such as Chlorella strains, undergo cell division faster in the presence of glycerol than in the presence of glucose. In these instances, two-stage growth processes in which cells are first fed glycerol to increase cell density, and are then fed glucose to accumulate lipids can improve the efficiency with which lipids are produced.

Other feedstocks for culturing microalgae under heterotrophic growth conditions for purposes of the present invention include mixtures of glycerol and glucose, mixtures of glucose and xylose, mixtures of fructose and glucose, sucrose, glucose, fructose, xylose, arabinose, mannose, galactose, acetate, and molasses. Other suitable feedstocks include corn stover, sugar beet pulp, and switchgrass in combination with depolymerization enzymes. In various embodiments of the invention, a microbe that can utilize sucrose as a carbon source under heterotrophic culture conditions is used to generate the microbial biomass. PCT Publication Nos. 2010/063032, 2010/063032, and 2008/151149 describe recombinant organisms, including but not limited to Prototheca and Chlorella microalgae, that have been genetically engineered to utilize sucrose as a carbon source. In various embodiments, these or other organisms capable of utilizing sucrose as a carbon source under heterotrophic conditions are cultured in media in which the sucrose is provided in the form of a crude, sucrose-containing material, including but not limited to, sugar cane juice (e.g., thick cane juice) and sugar beet juice.

For lipid and oil production, cells, including recombinant cells, are typically fermented in large quantities. The culturing may be in large liquid volumes, such as in suspension cultures as an example. Other examples include starting with a small culture of cells which expand into a large biomass in combination with cell growth and propagation as well as lipid (oil) production. Bioreactors or steel fermentors can be used to accommodate large culture volumes. For these fermentations, use of photosynthetic growth conditions may be impossible or at least impractical and inefficient, so heterotrophic growth conditions may be preferred.

Appropriate nutrient sources for culture in a fermentor for heterotrophic growth conditions include raw materials such as one or more of the following: a fixed carbon source such as glucose, corn starch, depolymerized cellulosic material, sucrose, sugar cane, sugar beet, lactose, milk whey, molasses, or the like; a nitrogen source, such as protein, soybean meal, cornsteep liquor, ammonia (pure or in salt form), nitrate or nitrate salt; and a phosphorus source, such as phosphate salts. Additionally, a fermentor for heterotrophic growth conditions allows for the control of culture conditions such as temperature, pH, oxygen tension, and carbon dioxide levels. Optionally, gaseous components, like oxygen or nitrogen, can be bubbled through a liquid culture. Other starch (glucose) sources include wheat, potato, rice, and sorghum. Other carbon sources include process streams such as technical grade glycerol, black liquor, and organic acids such as acetate, and molasses. Carbon sources can also be provided as a mixture, such as a mixture of sucrose and depolymerized sugar beet pulp.

A fermentor for heterotrophic growth conditions can be used to allow cells to undergo the various phases of their physiological cycle. As an example, an inoculum of lipid-producing cells can be introduced into a medium followed by a lag period (lag phase) before the cells begin to propagate. Following the lag period, the propagation rate increases steadily and enters the log, or exponential, phase. The exponential phase is in turn followed by a slowing of propagation due to decreases in nutrients such as nitrogen, increases in toxic substances, and quorum sensing mechanisms. After this slowing, propagation stops, and the cells enter a stationary phase or steady growth state, depending on the particular environment provided to the cells.

In one heterotrophic culture method useful for purposes of the present invention, microorganisms are cultured using depolymerized cellulosic biomass as a feedstock. As opposed to other feedstocks that can be used to culture microorganisms, such as corn starch or sucrose from sugar cane or sugar beets, cellulosic biomass (depolymerized or otherwise) is not suitable for human consumption. Cellulosic biomass (e.g., stover, such as corn stover) is inexpensive and readily available.

Suitable cellulosic materials include residues from herbaceous and woody energy crops, as well as agricultural crops, i.e., the plant parts, primarily stalks and leaves typically not removed from the fields with the primary food or fiber product. Examples include agricultural wastes such as sugarcane bagasse, rice hulls, corn fiber (including stalks, leaves, husks, and cobs), wheat straw, rice straw, sugar beet pulp, citrus pulp, citrus peels; forestry wastes such as hardwood and softwood thinnings, and hardwood and softwood residues from timber operations; wood wastes such as saw mill wastes (wood chips, sawdust) and pulp mill waste; urban wastes such as paper fractions of municipal solid waste, urban wood waste and urban green waste such as municipal grass clippings; and wood construction waste. Additional cellulosics include dedicated cellulosic crops such as switchgrass, hybrid poplar wood, and miscanthus, fiber cane, and fiber sorghum. Five-carbon sugars that are produced from such materials include xylose.

Some microbes are able to process cellulosic material and directly utilize cellulosic materials as a carbon source. However, cellulosic material may need to be treated to increase the accessible surface area or for the cellulose to be first broken down as a preparation for microbial utilization as a carbon source. PCT Patent Publication Nos. 2010/120939, 2010/063032, 2010/063031, and PCT 2008/151149, incorporated herein by reference, describe various methods for treating cellulose to render it suitable for use as a carbon source in microbial fermentations.

Bioreactors can be employed for heterotrophic growth and propagation methods. As will be appreciated, provisions made to make light available to the cells in photosynthetic growth methods are unnecessary when using a fixed-carbon source in the heterotrophic growth and propagation methods described herein.

The specific examples of process conditions and heterotrophic growth and propagation methods described herein can be combined in any suitable manner to improve efficiencies of microbial growth and lipid production. For example, microbes having a greater ability to utilize any of the above-described feedstocks for increased proliferation and/or lipid production may be used in the methods of the invention.

In certain embodiments of the present invention, the oleaginous microbe is cultured mixotrophically. Mixotrophic growth involves the use of both light and fixed carbon source(s) as energy sources for cultivating cells. Mixotrophic growth can be conducted in a photobioreactor. Microalgae can be grown and maintained in closed photobioreactors made of different types of transparent or semitransparent material. Such material can include Plexiglass® enclosures, glass enclosures, bags made from substances such as polyethylene, transparent or semi-transparent pipes and other material. Microalgae can be grown and maintained in open photobioreactors such as raceway ponds, settling ponds and other non-enclosed containers. The following discussion of photobioreactors useful for mixotrophic growth conditions is applicable to photosynthetic growth conditions as well.

Microorganisms useful in accordance with the methods of the present invention are found in various locations and environments throughout the world. As a consequence of their isolation from other species and their resulting evolutionary divergence, the particular growth medium for optimal growth and generation of oil and/or lipid from any particular species of microbe may need to be experimentally determined. In some cases, certain strains of microorganisms may be unable to grow on a particular growth medium because of the presence of some inhibitory component or the absence of some essential nutritional requirement required by the particular strain of microorganism. There are a variety of methods known in the art for culturing a wide variety of species of microalgae to accumulate high levels of lipid as a percentage of dry cell weight, and methods for determining optimal growth conditions for any species of interest are also known in the art.

Solid and liquid growth media are generally available from a wide variety of sources, and instructions for the preparation of particular media that is suitable for a wide variety of strains of microorganisms can be found, for example, online at http://www.utex.org/, a site maintained by the University of Texas at Austin for its culture collection of algae (UTEX). For example, various fresh water and salt water media include those shown in Table 4.

TABLE 4
Algal Media.

| Fresh Water Media | Salt Water Media |
|---|---|
| ½ CHEV Diatom Medium | 1% F/2 |
| ⅓ CHEV Diatom Medium | ½ Enriched Seawater Medium |
| ⅕ CHEV Diatom Medium | ½ Erdschreiber Medium |
| 1:1 DYIII/PEA + Gr+ | ½ Soil + Seawater Medium |
| ⅔ CHEV Diatom Medium | ⅓ Soil + Seawater Medium |
| 2X CHEV Diatom Medium | ¼ ERD |
| Ag Diatom Medium | ¼ Soil + Seawater Medium |
| Allen Medium | ⅕ Soil + Seawater Medium |
| BG11-1 Medium | ⅔ Enriched Seawater Medium |
| Bold 1NV Medium | 20% Allen + 80% ERD |
| Bold 3N Medium | 2X Erdschreiber's Medium |
| Botryococcus Medium | 2X Soil + Seawater Medium |
| Bristol Medium | 5% F/2 Medium |
| CHEV Diatom Medium | 5/3 Soil + Seawater Agar Medium |
| Chu's Medium | Artificial Seawater Medium |
| CR1 Diatom Medium | BG11-1 + .36% NaCl Medium |
| CR1+ Diatom Medium | BG11-1 + 1% NaCl Medium |
| CR1-S Diatom Medium | Bold 1NV:Erdshreiber (1:1) |
| Cyanidium edium | Bold 1NV:Erdshreiber (4:1) |
| Cyanophycean Medium | Bristol-NaCl Medium |
| Desmid Medium | Dasycladales Seawater Medium |
| DYIII Medium | Enriched Seawater Medium |
| Euglena Medium | Erdschreiber's Medium |
| HEPES Medium | ES/10 Enriched Seawater Medium |
| J Medium | ES/2 Enriched Seawater Medium |
| Malt Medium | ES/4 Enriched Seawater Medium |
| MES Medium | F/2 Medium |
| Modified Bold 3N Medium | F/2 + NH4 |
| Modified COMBO Medium | LDM Medium |
| N/20 Medium | Modified 2 X CHEV |
| Ochromonas Medium | Modified 2 X CHEV + Soil |
| P49 Medium | Modified Artificial Seawater Medium |
| Polytomella Medium | Modified CHEV |
| Proteose Medium | Porphridium Medium |
| Snow Algae Media | Soil + Seawater Medium |
| Soil Extract Medium | SS Diatom Medium |
| Soilwater: BAR Medium | |
| Soilwater: GR− Medium | |
| Soilwater: GR−/NH4 Medium | |
| Soilwater: GR+ Medium | |
| Soilwater: GR+/NH4 Medium | |
| Soilwater: PEA Medium | |
| Soilwater: Peat Medium | |
| Soilwater: VT Medium | |
| Spirulina Medium | |
| Tap Medium | |
| Trebouxia Medium | |
| Volvocacean Medium | |
| Volvocacean-3N Medium | |
| Volvox Medium | |
| Volvox-Dextrose Medium | |
| Waris Medium | |
| Waris + Soil Extract Medium | |

A medium suitable for culturing Chlorella protothecoides comprises Proteose Medium. This medium is suitable for axenic cultures, and a 1 L volume of the medium (pH ˜6.8) can be prepared by addition of 1 g of proteose peptone to 1 liter of Bristol Medium. Bristol medium comprises 2.94 mM NaNO₃, 0.17 mM CaCl₂.2H₂O, 0.3 mM MgSO₄.7H₂O, 0.43 mM, 1.29 mM KH₂PO₄, and 1.43 mM NaCl in an aqueous solution. For 1.5% agar medium, 15 g of agar can be added to 1 L of the solution. The solution is covered and autoclaved, and then stored at a refrigerated temperature prior to use.

Other suitable media for use with the methods of the invention can be readily identified by consulting the URL identified above, or by consulting other organizations that maintain cultures of microorganisms, SAG the Culture Collection of Algae at the University of Göttingen (Göttingen, Germany), CCAP the culture collection of algae and protozoa managed by the Scottish Association for Marine Science (Scotland, United Kingdom), and CCALA the culture collection of algal laboratory at the Institute of Botany (T\check{r}ebo\check{n}, Czech Republic).

The microbial biomass used in the methods of the invention can have a high lipid content (e.g., at least 10%, at least 20%, at least 30%, or higher lipids by dry weight) at some point during processing (for example, when spent biomass remaining after oil has been recovered from the microbes is used as a fluid loss control agent) or when incorporated into the drilling fluids of the invention. Process conditions can be adjusted to increase the percentage weight of cells that is lipid. For example, in certain embodiments, a microbe (e.g., a microalgae) is cultured in the presence of a limiting concentration of one or more nutrients, such as, for example, nitrogen and/or phosphorous and/or sulfur, while providing an excess of fixed carbon energy such as glucose. Nitrogen limitation tends to increase microbial lipid yield over microbial lipid yield in a culture in which nitrogen is provided in excess. In particular embodiments, the increase in lipid yield is from at least about 10% to 100% to as much as 500% or more. The microbe can be cultured in the presence of a limiting amount of a nutrient for a portion of the total culture period or for the entire period. In particular embodiments, the nutrient concentration is cycled between a limiting concentration and a non-limiting concentration at least twice during the total culture period. In one embodiment, the C10-C14 content of the microbial biomass used in the methods comprises at least about 10%, at least about 20%, at least about 30%, at least about 40%, at least about 50%, or at least about 60%, or at least 70% of the lipid content of the biomass. In another aspect, the saturated lipid content of the microbial biomass is at least about 50%, at least about 60%, at least about 70%, at least about 80%, or at least about 90% of the lipid of the microbial biomass.

To increase lipid as a percentage of dry cell weight, acetate can be employed in the feedstock for a lipid-producing microbe (e.g., a microalgae). Acetate feeds directly into the point of metabolism that initiates fatty acid synthesis (i.e., acetyl-CoA); thus providing acetate in the culture can increase fatty acid production. Generally, the microbe is cultured in the presence of a sufficient amount of acetate to increase microbial lipid yield, and/or microbial fatty acid yield, specifically, over microbial lipid (e.g., fatty acid) yield in the absence of acetate. Acetate feeding is a useful component of the methods provided herein for generating microalgal biomass that has a high percentage of dry cell weight as lipid.

In a steady growth state, the cells accumulate oil (lipid) but do not undergo cell division. In one embodiment of the invention, the growth state is maintained by continuing to provide all components of the original growth media to the cells with the exception of a fixed nitrogen source. Cultivating microalgae cells by feeding all nutrients originally provided to the cells except a fixed nitrogen source, such as through feeding the cells for an extended period of time, can result in a high percentage of dry cell weight being lipid. In some embodiments, the nutrients, such as trace metals, phosphates, and other components, other than a fixed carbon source, can be provided at a much lower concentration than originally provided in the starting fermentation to avoid “overfeeding” the cells with nutrients that will not be used by the cells, thus reducing costs.

In other embodiments, high lipid (oil) biomass can be generated by feeding a fixed carbon source to the cells after all fixed nitrogen has been consumed for extended periods of time, such as from at least 8 to 16 or more days. In some embodiments, cells are allowed to accumulate oil in the presence of a fixed carbon source and in the absence of a fixed nitrogen source for over 30 days. Preferably, microorganisms grown using conditions described herein and known in the art comprise lipid in a range of from at least about 10% lipid by dry cell weight to about 75% lipid by dry cell weight. Such oil rich biomass can be used directly as a fluid loss control agent in the drilling fluids of the invention, but often, the spent biomass remaining after lipid has been extracted from the microbes will be used as the fluid loss control agent.

Another tool for allowing cells to accumulate a high percentage of dry cell weight as lipid involves feedstock selection. Multiple species of Chlorella and multiple strains within a species of Chlorella accumulate a higher percentage of dry cell weight as lipid when cultured in the presence of biodiesel glycerol byproduct than when cultured in the presence of equivalent concentrations of pure reagent grade glycerol. Similarly, Chlorella can accumulate a higher percentage of dry cell weight as lipid when cultured in the presence of an equal concentration (weight percent) mixture of glycerol and glucose than when cultured in the presence of only glucose.

Another tool for allowing cells to accumulate a high percentage of dry cell weight as lipid involves feedstock selection as well as the timing of addition of certain feedstocks. For example, Chlorella can accumulate a higher percentage of dry cell weight as lipid when glycerol is added to a culture for a first period of time, followed by addition of glucose and continued culturing for a second period of time, than when the same quantities of glycerol and glucose are added together at the beginning of the fermentation. See PCT Publication No. 2008/151149, incorporated herein by reference.

The lipid (oil) percentage of dry cell weight in microbial lipid production can therefore be improved, at least with respect to certain cells, by the use of certain feedstocks and temporal separation of carbon sources, as well as by holding cells in a heterotrophic growth state in which they accumulate oil but do not undergo cell division. The examples below show growing various microbes, including several strains of microalgae, to accumulate higher levels of lipids as DCW.

Process conditions can be adjusted to increase the yields of lipids. Process conditions can also be adjusted to reduce production cost. For example, in certain embodiments, a microbe (e.g., a microalgae) is cultured in the presence of a limiting concentration of one or more nutrients, such as, for example, nitrogen, phosphorus, and/or sulfur. This condition tends to increase microbial lipid yield over microbial lipid yield in a culture in which the nutrient is provided in excess. In particular embodiments, the increase in lipid yield is at least about: 10% 20 to 500%.

Limiting a nutrient may also tend to reduce the amount of biomass produced. Therefore, the limiting concentration is typically one that increases the percentage yield of lipid for a given biomass but does not unduly reduce total biomass. In exemplary embodiments, biomass is reduced by no more than about 5% to 25%. The microbe can be cultured in the presence of a limiting amount of nutrient for a portion of the total culture period or for the entire period. In particular embodiments, the nutrient concentration is cycled between a limiting concentration and a non-limiting concentration at least twice during the total culture period.

The microbial biomass generated by the culture methods described herein comprises microalgal oil (lipid) as well as other constituents generated by the microorganisms or incorporated by the microorganisms from the culture medium during fermentation.

Microalgal biomass with a high percentage of oil/lipid accumulation by dry weight has been generated using different methods of culture known in the art. Microalgal biomass with a higher percentage of oil/lipid accumulation is useful in with the methods of the present invention. Li et al. describe Chlorella vulgaris cultures with up to 56.6% lipid by dry cell weight (DCW) in stationary cultures grown under autotrophic conditions using high iron (Fe) concentrations (Li et al., Bioresource Technology 99(11):4717-22 (2008). Rodolfi et al. describe Nanochloropsis sp. and Chaetoceros calcitrans cultures with 60% lipid DCW and 39.8% lipid DCW, respectively, grown in a photobioreactor under nitrogen starvation conditions (Rodolfi et al., Biotechnology & Bioengineering (2008) [June 18 Epub ahead of print]). Solovchenko et al. describe Parietochloris incise cultures with approximately 30% lipid accumulation (DCW) when grown phototropically and under low nitrogen condtions (Solovchenko et al., Journal of Applied Phycology 20:245-251 (2008). Chlorella protothecoides can produce up to 55% lipid (DCW) grown under certain heterotrophic conditions with nitrogen starvation (Miao and Wu, Bioresource Technology 97:841-846 (2006). Other Chlorella species including Chlorella emersonii, Chlorella sorokiniana and Chlorella minutissima have been described to have accumulated up to 63% oil (DCW) when grown in stirred tank bioreactors under low-nitrogen media conditions (Illman et al., Enzyme and Microbial Technology 27:631-635 (2000). Still higher percent lipid accumulation by dry cell weight have been reported, including 70% lipid (DCW) accumulation in Dumaliella tertiolecta cultures grown in increased NaCl conditions (Takagi et al., Journal of Bioscience and Bioengineering 101(3): 223-226 (2006)) and 75% lipid accumulation in Botryococcus braunii cultures (Banerjee et al., Critical Reviews in Biotechnology 22(3): 245-279 (2002)).

After the desired amount of oleaginous microbial biomass has been accumulated by fermentation, the biomass is collected and treated, optionally including a lipid extraction step, to prepare the biomass for use as a fluid in accordance with the various embodiments of the present invention.

### III. Preparation of Microbial Biomass and Spent Biomass

After fermentation to accumulate the biomass, one or more steps of removing water (or other liquids) from the microbial biomass are typically conducted. These steps of removing water can include the distinct steps referred to herein as dewatering and drying.

Dewatering, as used herein, refers to the separation of the oil-containing microbe from the fermentation broth (liquids) in which it was cultured. Dewatering, if performed, should be performed by a method that does not result in, or results only in minimal loss in, oil content of the biomass. Accordingly, care is generally taken to avoid cell lysis during any dewatering step. Dewatering is a solid-liquid separation and involves the removal of liquids from solid material. Common processes for dewatering include centrifugation, filtration, and/or the use of mechanical pressure.

Microbial biomass useful in the methods and compositions of the present invention can be dewatered from the fermentation broth through the use of centrifugation, to form a concentrated paste. After centrifugation, there is still a substantial amount of surface or free moisture in the microbial biomass (e.g., upwards of 70%) and thus, centrifugation is not considered to be, for purposes of the present invention, a drying step. Optionally, after centrifugation, the biomass can be washed with a washing solution (e.g., deionized water) to remove remaining fermentation broth and debris.

In some embodiments, dewatering involves the use of filtration. One example of filtration that is suitable for the present invention is tangential flow filtration (TFF), also known as cross-flow filtration. Tangential flow filtration is a separation technique that uses membrane systems and flow force to purify solids from liquids. For a preferred filtration method see Geresh, Carb. Polym. 50; 183-189 (2002), which discusses use of a MaxCell A/G technologies 0.45 uM hollow fiber filter. Also see for example Millipore Pellicon® devices, used with 100 kD, 300 kD, 1000 kD (catalog number P2C01MC01), 0.1 uM (catalog number P2VVPPV01), 0.22 uM (catalog number P2GVPPV01), and 0.45 uM membranes (catalog number P2HVMPV01). The retentate should not pass through the filter at a significant level. The retentate also should not adhere significantly to the filter material. TFF can also be performed using hollow fiber filtration systems.

Non-limiting examples of tangential flow filtration include those involving the use of a filter with a pore size of at least about 0.1 micrometer, at least about 0.12 micrometer, at least about 0.14 micrometer, at least about 0.16 micrometer, at least about 0.18 micrometer, at least about 0.2 micrometer, at least about 0.22 micrometer, at least about 0.45 micrometer, or at least about 0.65 micrometers. Preferred pore sizes of TFF allow solutes and debris in the fermentation broth to flow through, but not microbial cells.

In other embodiments, dewatering involves the use of mechanical pressure directly applied to the biomass to separate the liquid fermentation broth from the microbial biomass. The amount of mechanical pressure applied should not cause a significant percentage of the microbial cells to rupture, if that would result in loss of oil, but should instead simply be enough to dewater the biomass to the level desired for subsequent processing.

One non-limiting example of using mechanical pressure to dewater microbial biomass employs the belt filter press. A belt filter press is a dewatering device that applies mechanical pressure to a slurry (e.g., microbial biomass that is directly from the fermentor or bioreactor) that is passed between the two tensioned belts through a serpentine of decreasing diameter rolls. The belt filter press can actually be divided into three zones: gravity zone, where free draining water/liquid is drained by gravity through a porous belt; a wedge zone, where the solids are prepared for pressure application; and a pressure zone, where adjustable pressure is applied to the gravity drained solids.

One or more of the above dewatering techniques can be used alone or in combination to dewater the microbial biomass for use in the present invention. The moisture content of the microbial biomass (conditioned feedstock) can affect the yield of oil obtained in the pressing step (if oil is to be extracted therefrom, as described below, prior to use as a fluid loss control agent), and that the optimal moisture level, which for some strains of microalgae is below 6% and preferably below 2%, can vary from organism to organism (see PCT Publication No. 2010/120939, incorporated herein by reference).

Drying, as referred to herein, refers to the removal of some or all of the free moisture or surface moisture of the microbial biomass. Like dewatering, the drying process typically does not result in significant loss of oil from the microbial biomass. Thus, the drying step should typically not cause lysis of a significant number of the microbial cells, because in most cases, the lipids are located in intracellular compartments of the microbial biomass. Several methods of drying microbial biomass known in the art for other purposes are suitable for use in the methods of the present invention. Microbial biomass after the free moisture or surface moisture has been removed is referred to as dried microbial biomass. If no further moisture removal occurs in the conditioning or moisture reduction occurs via the addition of a dry bulking agent prior to the pressing step, then the dried microbial biomass may contain, for example and without limitation, less than 6% moisture by weight. Non-limiting examples of drying methods suitable for use in preparing dry microbial biomass in accordance with the methods of the invention include lyophilization and the use of dryers such as a drum dryer, spray dryer, and a tray dryer, each of which is described below.

Lyophilization, also known as freeze drying or cryodessication, is a dehydration process that is typically used to preserve a perishable material. The lyophilization process involves the freezing of the material and then reducing the surrounding pressure and adding enough heat to allow the frozen water in the material to sublime from the solid phase to gas. In the case of lyophilizing microbial biomass, such as microalgae derived biomass, the cell wall of the microalgae acts as a cryoprotectant that prevents degradation of the intracellular lipids during the freeze dry process.

Drum dryers are one of the most economical methods for drying large amounts of microbial biomass. Drum dryers, or roller dryers, consist of two large steel cylinders that turn toward each other and are heated from the inside by steam. In some embodiments, the microbial biomass is applied to the outside of the large cylinders in thin sheets. Through the heat from the steam, the microbial biomass is then dried, typically in less than one revolution of the large cylinders, and the resulting dry microbial biomass is scraped off of the cylinders by a steel blade. The resulting dry microbial biomass has a flaky consistency. In various embodiments, the microbial biomass is first dewatered and then dried using a drum dryer. More detailed description of a drum dryer can be found in U.S. Pat. No. 5,729,910, which discloses a rotary drying drum.

Spray drying is a commonly used method of drying a liquid feed using a hot gas. A spray dryer takes a liquid stream (e.g., containing the microbial biomass) and separates the solute as a solid and the liquid into a vapor. The liquid input stream is sprayed through a nozzle into a hot vapor stream and vaporized. Solids form as moisture quickly leaves the droplets. The nozzle of the spray dryer is adjustable, and typically is adjusted to make the droplets as small as possible to maximize heat transfer and the rate of water vaporization. The resulting dry solids may have a fine, powdery consistency, depending on the size of the nozzle used. In other embodiments, spray dryers can use a lyophilization process instead of steam heating to dry the material.

Tray dryers are typically used for laboratory work and small pilot scale drying operations. Tray dryers work on the basis of convection heating and evaporation. Fermentation broth containing the microbial biomass can be dried effectively from a wide range of cell concentrations using heat and an air vent to remove evaporated water.

Flash dryers are typically used for drying solids that have been de-watered or inherently have a low moisture content. Also known as “pneumatic dryers”, these dryers typically disperse wet material into a stream of heated air (or gas) which conveys it through a drying duct. The heat from the airstream (or gas stream) dries the material as it is conveyed through the drying duct. The dried product is then separated using cyclones and/or bag filters. Elevated drying temperatures can be used with many products, because the flashing off of surface moisture instantly cools the drying gas/air without appreciably increasing the product temperature. More detailed descriptions of flash dryers and pneumatic dryers can be found in U.S. Pat. No. 4,214,375, which describes a flash dryer, and U.S. Pat. Nos. 3,789,513 and 4,101,264, which describe pneumatic dryers.

Dewatered and/or dried microbial biomass may be conditioned prior to a pressing step, as described below, if one is obtaining spent biomass for use in accordance with the invention. Conditioning of the microbial biomass refers to heating the biomass to a temperature in the range of 70° C. to 150° C. (160° F. to 300° F.) and changing the physical or physiochemical nature of the microbial biomass and can be used to improve oil yields in a subsequent oil extraction (pressing) step. Conditioning microbial biomass results in the production of “conditioned feedstock.” In addition to heating or “cooking” the biomass, non-limiting examples of conditioning the biomass include adjusting the moisture content within the dry microbial biomass, subjecting the dry microbial biomass to a low pressure “pre-press”, subjecting the dry microbial biomass to cycles of heating and cooling, subjecting the dry microbial biomass to an expander, and/or adjusting the particle size of the dry microbial biomass.

The conditioning step can include techniques (e.g., heating or application or pressure) that overlap in part with techniques used in the drying or pressing steps. However, the primary goals of these steps are different: the primary goal of the drying step is the removal of some or all of the free moisture or surface moisture from the microbial biomass. The primary goal of the conditioning step is to heat the biomass, which can optionally result in the removal of intracellular water from, i.e., adjusting the intracellular moisture content of, the microbial biomass and/or altering the physical or physiochemical nature of the microbial biomass without substantial release of lipids to facilitate release of oil during the pressing step. The primary the goal of the pressing step is to release oil from the microbial biomass or conditioned feedstock, i.e., the extraction of the oil.

In various embodiments, conditioning involves altering, or adjusting, the moisture content of the microbial biomass by the application of heat, i.e., heat conditioning. Heat conditioning, as used herein, refers to heat treatment (either direct or indirect) of microbial biomass. The moisture content of the microbial biomass can be adjusted by conditioning using heat (either direct or indirect), which is typically done, if at all, after a drying step. Even though the biomass may be dried by any of the above described methods, the moisture content of the microbial biomass after drying can range, for example, from 3% to 15% moisture by weight, or 5-10% moisture by weight. Such a moisture range may not be optimal for maximal oil recovery in the pressing step. Therefore, there may be benefit in heat-conditioning dewatered and/or dry microbial biomass to adjust the moisture level to a level (below 6%) optimal for maximal oil recovery.

Heat conditioners used in oil seed processing are suitable for use in conditioning microbial biomass in accordance with the methods of the present invention, such as vertical stacked conditioners. These consist of a series of three to seven or more closed, superimposed cylindrical steel pans. Each pan is independently jacketed for steam heating on both sides and bottom and is equipped with a sweep-type stirrer mounted close to the bottom, and operated by a common shaft extending through the entire series of pans. The temperature of the heat conditioner is also adjustable through regulation of the steam heating. There is an automatically operated gate in the bottom of each pan, except the last, for discharging the contents to the pan below. The top pan is provided with spray jets for the addition of moisture if desired. While moisture is sprayed onto seeds in many agricultural oil extraction processes during conditioning, this common process is not desirable for conditioning microbial biomass. Cookers also typically have an exhaust pipe and fan for removal of moisture. Thus, it is possible to control the moisture of the microbial biomass, not only with respect to final moisture content but also at each stage of the operation. In this respect, a conditioning step of heating microbial biomass for an extended period of time (10-60 minutes for example) provides the effect of not only reducing moisture and increasing the temperature of the biomass, but also altering the biophysical nature of the microbial biomass beyond any heating effects that might occur in a subsequent pressing step, i.e., simply from friction of the material as it is forced through, e.g., a press.

Additionally, a steam jacketed horizontal cooker is another type of heat conditioner that is suitable for use in accordance with the methods of the invention herein. In this design, the biomass is mixed, heated and conveyed in a horizontal plane in deeper beds as compared to conventional vertical stacked cookers. In the horizontal cooker, the action of a specially designed auger mixes conveys the biomass, while the biomass is simultaneously heated with indirect steam from the steam jacket. Water and vapor and air are vented out from the cooker through an upper duct, which may or may not have an exhaust fan depending on the cooker's capacity. For cooking biomass at a high flow rate, several horizontal cookers can be stacked together. In this configuration, the biomass is fed into the top level cooker and heated and conveyed through by the auger and then thrown by gravity into a lower level cooker where the process is repeated. Several levels of horizontal cookers can be stacked together depending on the needed flow rate and the time/temperature of conditioning required. Moisture and temperature can be monitored and adjusted independently for each horizontal cooker level.

For the heat conditioning of microbial biomass, especially microalgal biomass, the optimal time and temperature that the biomass spends in a vertical stacked conditioner can vary depending on the moisture level of the biomass after drying. Heat conditioning (sometimes referred to as “cooking”) should not result in burning or scorching significant amounts of the microbial biomass during cooking Depending on the moisture content of the microbial biomass prior to heat conditioning, i.e., for very low levels of moisture, it may be beneficial or even necessary to moisten the biomass before heat conditioning to avoid burning or scorching. Depending on the type of microbial biomass that is going to be fed through an expeller press, the optimal temperature for heat conditioning will vary. For some species of microalgae, the optimal temperature for heat conditioning is between 200-270° F. In some embodiments, the microalgal biomass is heat conditioned at 210-230° F. In other embodiments, the microalgal biomass is heat conditioned at 220-270° F. In still other embodiments, the microalgal biomass is heat conditioned at 240-260° F.

Heating the oil-bearing microbial biomass before pressing can aid in the liberation of oil from and/or accessing the oil-laden compartments of the cells. Oil-bearing microbial biomass contains the oil in compartments made of cellular components such as proteins and phospholipids. Repetitive cycles of heating and cooling can denature the proteins and alter the chemical structure of the cellular components of these oil compartments and thereby provide better access to the oil during the subsequent extraction process. Thus, in various embodiments of the invention, the microbial biomass is conditioned to prepare conditioned feedstock that is used in the pressing step, and the conditioning step involves heating and, optionally, one or more cycles of heating and cooling.

If no further heat conditioning or other conditioning that alters moisture content is to be performed, and if no bulking agent that will alter moisture content is to be added, then the conditioned feedstock resulting from heat conditioning may be adjusted to contain less than a certain percentage of moisture by weight. For example, it may be useful to employ microalgal biomass having less than 6% moisture by weight in the drilling fluids of the invention. In various embodiments, the microbial biomass has a moisture content in the range of 0.1% to 5% by weight. In various embodiments, the microbial biomass has a moisture content of less than 4% by weight. In various embodiments, the microbial biomass has a moisture content in the range of 0.5% to 3.5% by weight. In various embodiments, the microbial biomass has a moisture content in the range of 0.1% to 3% by weight.

In addition to heating the biomass, conditioning can, in some embodiments, involve the application of pressure to the microbial biomass. To distinguish this type of conditioning from the pressure applied during oil extraction (the pressing step, if employed), this type of conditioning is referred to as a “pre-press.” The pre-press is conducted at low pressure, a pressure lower than that used for oil extraction in the pressing step. Ordinary high-pressure expeller (screw) presses may be operated at low pressure for this pre-press conditioning step. Pre-pressing the biomass at low pressure may aid in breaking open the cells to allow for better flow of oil during the subsequent high pressure pressing; however, pre-pressing does not cause a significant amount (e.g. more than 5%) of the oil to separate from the microbial biomass. Also, the friction and heat generated during the pre-press may also help break open the oil compartments in the cells. Pre-pressing the biomass at low pressure also changes the texture and particle size of the biomass, because the biomass will extrude out of the press in a pellet-like form. In some embodiments, an extruder (see discussion below) is used to achieve the same or similar results as a low pressure pre-press conditioning step. In some embodiments, the pellets of conditioned biomass are further processed to achieve an optimal particle size for the subsequent full pressure pressing.

Thus, another parameter relevant to optimal extraction of oil from microbial biomass is the particle size. Typically, the optimum particle size for an oil expeller press (screw press) is approximately 1/16^{th} of an inch thick. Factors that may affect the range of particle size include, but are not limited to, the method used to dry the microbial biomass and/or the addition of a bulking agent or press aid to the biomass. If the biomass is tray dried, e.g., spread wet onto a tray and then dried in an oven, the resulting dried microbial biomass may need to be broken up into uniform pieces of the optimal particle size to make it optimal for pressing in an expeller press. The same is true if a bulking agent is added to the microbial biomass before the drying process. Thus, conditioning may involve a step that results in altering the particle size or average particle size of the microbial biomass. Machines such as hammer mills or flakers may be employed in accordance with the methods of the invention to adjust the thickness and particle size of the oil-bearing microbial biomass.

In similar fashion, improved oil extraction can result from altering other physical properties of the dried microbial biomass. In particular, the porosity and/or the density of the microbial biomass can affect oil extraction yields. In various embodiments of the methods of the invention, conditioning of the biomass to alter its porosity and/or density is performed. Expanders and extruders increase the porosity and the bulk density of the biomass. Expanders and extruders can be employed to condition the microbial biomass. Both expanders and extruders are low-shear machines that heat, homogenize, and shape oil-bearing material into collets or pellets. Expanders and extruders work similarly; both have a worm/collar setup inside a shaft such that, as it moves the material inside the shaft, mechanical pressure and shearing break open the cells. The biggest difference between expanders and extruders is that the expander uses water and/or steam to puff the material at the end of the shaft. The sudden high pressure (and change in pressure) causes the moisture in the material to vaporize, thus “puffing” or expanding the material using the internal moisture. Extruders change the shape of the material, forming collets or pellets. Extruders also lyse the cells and vaporizes water from the biomass (reduction of moisture) while increasing the temperature of the biomass (heating the biomass) through mechanical friction that the extruder exerts on the biomass. Thus, extruders and expanders can be used in accordance with the methods of the invention to condition the microbial biomass. The extruder/expanders can break open the cells, freeing the intracellular lipids, and can also change the porosity and the bulk density of the material. These changes in the physical properties of the feedstock may be advantageous in subsequent oil extraction or for the particular drilling application for which a drilling fluid of the invention may be employed.

The above-described conditioning methods can be used alone or in combination in accordance with the methods of the invention to achieve the optimal conditioned microbial biomass feedstock for subsequent oil extraction and/or the particular drilling application for which a drilling fluid of the invention may be employed. Thus, the conditioning step involves the application of heat and optionally pressure to the biomass. In various embodiments, the conditioning step comprises heating the biomass at a temperature in the range of 70° C. to 150° C. (160° F. to 300° F.). In various embodiments, the heating is performed using a vertical stacked shaker. In various embodiments, the conditioning step further comprises treating the dry biomass with an expander or extruder to shape and/or homogenize the biomass.

In various embodiments of the invention, particularly those in which spent biomass is employed as a fluid loss control agent, a bulking agent or press aid is added to the microbial biomass, which may be either dry or hydrated (i.e., biomass that has not been dried or that contains significant, i.e., more than 6% by weight, moisture, including biomass in fermentation broth that has not been subjected to any process to remove or separate water) microbial biomass or conditioned feedstock. If spent biomass is to be employed, then the bulking agent is typically added prior to the pressing step. In various embodiments, the bulking agent has an average particle size of less than 1.5 mm. In some embodiments, the bulking agent or press aid has a particle size of between 50 microns and 1.5 mm. In other embodiments, the press aid has a particle size of between 150 microns and 350 microns. In some embodiments, the bulking agent is a filter aid. In various embodiments, the bulking agent is selected from the group consisting of cellulose, corn stover, dried rosemary, soybean hulls, spent biomass (biomass of reduced lipid content relative to the biomass from which it was prepared), including spent microbial biomass, sugar cane bagasse, and switchgrass. In various embodiments, the bulking agent is spent microbial biomass that contains between 40% and 90% polysaccharide by weight, such as cellulose, hemicellulose, soluble and insoluble fiber, and combinations of these different polysaccharides and/or less than 10% oil by weight. In various embodiments, the polysaccharide in the spent microbial biomass used as a bulking agent contains 20-30 mole percent galactose, 55-65 mole percent glucose, and/or 5-15 mole percent mannose.

Thus, the addition of a press aid or bulking agent may be advantageous in some embodiments of the invention. When there is high oil content and low fiber in the biomass, feeding the biomass through a press can result in an emulsion. This results in low oil yields, because the oil is trapped within the solids. One way in accordance with the methods of the invention to improve the yield in such instances is to add polysaccharide to the biomass in the form of a bulking agent, also known as a “press aid” or “pressing aid”. Bulking agents are typically high fiber additives that work by adjusting the total fiber content of the microbial biomass to an optimal range. Microbial biomass such as microalgae and the like typically have very little crude fiber content. Typically, the microbial biomass including microalgae biomass can have a crude fiber content of less than 2%. The addition of high fiber additives (in the form of a press aid) may help adjust the total fiber content of the microbial biomass to an optimal range for oil extraction using an expeller press or for a particular drilling fluid application. Optimal fiber content for a typical oil seed may range from 10-20%. In accordance with the methods of the present invention, it may be helpful to adjust the fiber content of the microbial biomass for optimal oil extraction or for a particular drilling fluid application. The range for fiber content in the biomass may be the same or a similar range as the optimal fiber content for a typical oil seed, although the optimal fiber content for each microbial biomass may be lower or higher than the optimal fiber content of a typical oil seed. Suitable pressing aids include, but are not limited to, switchgrass, rice straw, sugar beet pulp, sugar cane bagasse, soybean hulls, dry rosemary, cellulose, corn stover, delipidated (either pressed or solvent extracted) cake from soybean, canola, cottonseed, sunflower, jatropha seeds, paper pulp, waste paper and the like. In some embodiments, the spent microbial biomass of reduced lipid content from a previous press is used as a bulking agent. Thus, bulking agents, when incorporated into a biomass, change the physiochemical properties of the biomass so as to facilitate more uniform application of pressure to cells in the biomass.

In some cases, the bulking agent can be added to the microbial biomass after it has been dried, but not yet conditioned. In such cases, it may advantageous to mix the dry microbial biomass with the desired amount of the press aid and then condition the microbial biomass and the press aid together, i.e., before feeding to a screw press if spent biomass is to be used as the fluid loss control agent. In other cases, the press aid can be added to a hydrated microbial biomass before the microbial biomass has been subjected to any separation or dewatering processes, drying, or conditioning. In such cases, the press aid can be added directly to the fermentation broth containing the microbial biomass before any dewatering or other step.

Biomass useful as a fluid loss control agent can be obtained by various methods that employ bulking agents such as those described above. In one method, hydrated microbial biomass is prepared by adding a bulking agent to the biomass and drying the mixture obtained thereby to a desired moisture content, i.e., less than 6% by weight, thereby forming a dried bulking agent/biomass mixture. In another method, oil is extracted from microbial biomass and spent biomass is obtained by co-drying hydrated microbial biomass containing at least 20% oil (including at least 40% oil) by weight and a bulking agent to form a dried bulking agent/biomass mixture; optionally reducing the moisture content in the mixture, i.e., to less than 4% by weight, by drying and/or conditioning; and pressing the reduced moisture content mixture to extract oil therefrom, thereby forming spent biomass of reduced lipid content.

While oleaginous microbial biomass, prepared as described above, can be directly used as a fluid loss control agent in accordance with the invention, spent microbial biomass can also be used a fluid loss control agent. Given the value of microbial oil, spent microbial biomass may be more commonly used as a fluid loss control agent, and methods of preparing such spent biomass are described below.

For example, conditioned feedstock, optionally comprising a bulking agent, is subjected to pressure in a pressing step to extract oil, producing oil separated from the spent biomass. The pressing step involves subjecting pressure sufficient to extract oil from the conditioned feedstock. Thus, in some embodiments, the conditioned feedstock that is pressed in the pressing step comprises oil predominantly or completely encapsulated in cells of the biomass. In other embodiments, the biomass comprises predominantly lysed cells and the oil is thus primarily not encapsulated in cells.

In various embodiments of the different aspects of the invention, the pressing step will involve subjecting the conditioned feedstock to at least 10,000 psi of pressure. In various embodiments, the pressing step involves the application of pressure for a first period of time and then application of a higher pressure for a second period of time. This process may be repeated one or more times (“oscillating pressure”). In various embodiments, moisture content of conditioned feedstock is controlled during the pressing step. In various embodiments, the moisture is controlled in a range of from 0.1% to 3% by weight.

In various embodiments, the pressing step is conducted with an expeller press. In various embodiments, the pressing step is conducted in a continuous flow mode. In various embodiments, the oiling rate is at least 500 g/min. to no more than 1000 g/min. In various continuous flow embodiments, the expeller press is a device comprising a continuously rotating worm shaft within a cage having a feeder at one end and a choke at the opposite end, having openings within the cage is utilized. The conditioned feedstock enters the cage through the feeder, and rotation of the worm shaft advances the feedstock along the cage and applies pressure to the feedstock disposed between the cage and the choke, the pressure releasing oil through the openings of cage and extruding spent biomass from the choke end of the cage.

The cage on some expeller press can be heated using steam or cooled using water depending on the optimal temperature needed for maximum yield. Optimal temperature should be enough heat to aid in pressing, but not too high heat as to burn the biomass while it feeds through the press. The optimal temperature for the cage of the expeller press can vary depending on the microbial biomass that is to be pressed. In some embodiments, for pressing microbial or microalgal biomass, the cage is preheated and held to a temperature of between 200-270° F. In other embodiments, the optimal cage temperature for microbial or some species of microalgal biomass is between 210-230° F. In still other embodiments, the optimal cage temperature for microbial or some species of microalgal biomass is between 240-260° F.

In various embodiments, pressure is controlled by adjusting rotational velocity of a worm shaft. In various embodiments, including those in which pressure is not controlled, an expeller (screw) press comprising a worm shaft and a barrel can be used.

Expeller presses (screw presses) are routinely used for mechanical extraction of oil from soybeans and oil seeds. Generally, the main sections of an expeller press include an intake, a rotating feeder screw, a cage or barrel, a worm shaft and an oil pan. The expeller press is a continuous cage press, in which pressure is developed by a continuously rotating worm shaft. An extremely high pressure, approximately 10,000-20,000 pounds per square inch, is built up in the cage or barrel through the action of the worm working against an adjustable choke, which constricts the discharge of the pressed cake (spent biomass) from the end of the barrel. In various embodiments, screw presses from the following manufacturers are suitable for use: Anderson International Corp. (Cleveland, Ohio), Alloco (Santa Fe, Argentina), De Smet Rosedowns (Humberside, UK), The Dupps Co. (Germantown, Ohio), Grupo Tecnal (Sao Paulo, Brazil), Insta Pro (Des Moines, Iowa), French Oil Mill (Piqua, Ohio), Harburg Freudenberger (previously Krupp Extraktionstechnik) (Hamburg, Germany), Maschinenfabrik Reinartz (Neuss, Germany), Shann Consulting (New South Wales, Australia) and SKET (Magdeburg, Germany).

Microbial biomass or conditioned feedstock is supplied to the expeller press via an intake. A rotating feeder screw advances the material supplied from the intake into the barrel where it is then compressed by rotation of the worm shaft. Oil extracted from the material is then collected in an oil pan and then pumped to a storage tank. The remaining spent biomass is then extruded out of the press as a cake and can be collected for additional processing. The cake may be pelletized.

The worm shaft is associated with a collar setup and is divided into sections. The worm and collar setup within each section is customizable. The worm shaft is responsible for conveying biomass (feedstock) through the press. It may be characterized as having a certain diameter and a thread pitch. Changing shaft diameter and pitch can increase or decrease the pressure and shear stress applied to feedstock as it passes through the press. The collar's purpose is to increase the pressure on the feedstock within the press and also apply a shear stress to the biomass.

The worm shaft preferably is tapered so that its outer diameter increases along the longitudinal length away from the barrel entrance. This decreases the gap between the worm shaft and the inside of the barrel thus creating greater pressure and shear stress as the biomass travels through the barrel. Additionally, the interior of the barrel is made up of flat steel bars separated by spacers (also referred to as shims), which are set edgewise around the periphery of the barrel, and are held in place by a heavy cradle-type cage. Adjusting the shim between the bars controls the gap between the bars which helps the extracted oil to drain as well as also helping to regulate barrel pressure. The shims are often from 0.003″ thick to 0.030″ thick and preferably from 0.005″ to 0.020″ thick, although other thicknesses may also be employed. Additionally, the bars may be adjusted, thereby creating sections within the barrel.

As the feed material is pressed or moved down the barrel, significant heat is generated by friction. In some cases, the amount of heat is controlled using a water-jacketed cooling system that surrounds the barrel. Temperature sensors may be disposed at various locations around the barrel to monitor and aid in temperature control. Additionally, pressure sensors may also be attached to the barrel at various locations to help monitor and control the pressure.

Various operating characteristics of the expeller (screw) press can be expressed or analyzed as a compression ratio. Compression ratio is the ratio of the volume of material displaced per revolution of the worm shaft at the beginning of the barrel divided by the volume of material displaced per revolution of the worm shaft at the end of the barrel. For example, due to increasing compression ratios the pressure may be 10 to 18 times higher at the end of the barrel as compared with the beginning of the barrel. Internal barrel length may be at least ten times or even thirteen times the internal barrel diameter. Typical compression ratio for a screw or expeller press ranges from 1 to 18, depending on the feed material.

Residence time of the feed material in an expeller (screw) press may affect the amount of oil recovery. Increased residence time in the press gives the feedstock more exposure to the shear stress and pressure generated by the press, which may yield higher oil recovery. Residence time of the feedstock depends on the speed at which the press is run and the length vs. diameter of the screw press (or L/D). The greater the ratio of the length of the shaft to the diameter of the shaft, the longer the residence time of the feedstock (when rotational speed is held at a constant). In some embodiments, the residence time of the biomass that is being pressed with an expeller press is no more than to 10 minutes.

The resulting pressed solids or cake (spent biomass of reduced oil content relative to the feedstock supplied to the screw press) is expelled from the expeller press through the discharge cone at the end of the barrel/shaft. The choke utilizes a hydraulic system to control the exit aperture on the expeller press. A fully optimized oil press operation can extract most of the available oil in the oil-bearing material. A variety of factors can affect the residual oil content in the pressed cake. These factors include, but are not limited to, the ability of the press to rupture oil-containing cells and cellular compartments and the composition of the oil-bearing material itself, which can have an affinity for the expelled oil. In some cases, the oil-bearing material may have a high affinity for the expelled oil and can absorb the expelled oil back into the material, thereby trapping it. In that event, the oil remaining in the spent biomass can be re-pressed or subjected to solvent extraction, as described herein, to recover the oil. Methods for using an expeller press to prepare spent biomass are described in PCT Publication No. 2010/120939, incorporated herein by reference.

These oil extraction methods result in the production of microbial biomass of reduced oil content (spent biomass also referred to as pressed cake or pressed biomass) relative to the conditioned feedstock subjected to pressure in the pressing step. In various embodiments of the present invention, the oil content in the spent biomass of reduced oil content is at least 45 percent less than the oil content of the microbial biomass before the pressing step. In various embodiments, the spent biomass of reduced oil content remaining after the pressing step is pelletized or extruded as a cake. The spent cake, which may be subjected to additional processes, including additional conditioning and pressing or solvent-based extraction methods to extract residual oil, is useful as a fluid loss control agent.

In some instances, the pressed cake contains a range of from less than 50% oil to less than 1% oil by weight, including, for example, less than 40% oil by weight, less than 20% oil by weight, less than 10%, less than 5% oil by weight, and less than 2% oil by weight. In all cases, the oil content in the pressed cake is less than the oil content in the unpressed material.

In some embodiments, the spent biomass or pressed cake is collected and subjected to one or more of the dewatering, drying, heating, and conditioning methods described above prior to use as a fluid loss control agent. In addition, the spent biomass may be crushed, pulverized, or milled prior to such use.

### IV. Drilling, Production, and Pumping-Services Fluids

The fluids of the invention include aqueous and non-aqueous drilling fluids and other well-related fluids including those used for production of oil or natural gas, for completion operations, sand control operations, workover operations, and for pumping-services such as cementing, hydraulic fracturing, and acidification. In one embodiment of the invention, a fluid includes a fluid loss control agent that is biomass from an oleaginous microbe. In one embodiment, the biomass comprises intact, lysed or partly lysed cells with greater than 5%, 10%, 20%, 30%, 40%, 50%, 60%, 70%, 80%, or 90% oil. In another embodiment, the biomass is spent biomass from which oil has been removed. For example, the oil may be removed by a process of drying and pressing and optionally solvent-extracting with hexane or other suitable solvent. In a specific embodiment, the biomass is dried to less than 6% moisture by weight, followed by application of pressure to release more than 25% of the lipid. Alternately, the cells may be intact, which, when used in a drilling fluid, may impart improved fluid-loss control in certain circumstances. Generally, the drilling fluid of the invention contains about 0.1% to about 20% by weight of said biomass, but in various embodiments, this amount may range from about 0.1% to about 10% by weight of said biomass; from about 0.1% to about 5% by weight of said biomass; from about 0.5% to about 4% by weight of said biomass; and from about 1% to about 4% by weight of said biomass.

In various embodiments, the fluid comprises a fluid loss control agent that is not derived from oleaginous microbial biomass. Suitable fluid loss control agents may include, but are not limited to, unmodified starch, hydroxypropl starch, carboxymethyl starch, unmodified cellulose, carboxymethylcellulose, hydroxyethyl cellulose, and polyanionic cellulose.

The fluid can include an aqueous or non-aqueous solvent. The fluid can also optionally include one or more additional components so that the fluid is operable as a drilling fluid, a drill-in fluid, a workover fluid, a spotting fluid, a cementing fluid, a reservoir fluid, a production fluid, a fracturing fluid, or a completion fluid.

In various embodiments, the fluid is a drilling fluid and the added biomass from the oleaginous microbe serves to help transport cuttings, lubricate and protect the drill bit, support the walls of the well bore, deliver hydraulic energy to the formation beneath the bit, and/or to suspend cuttings in the annulus when drilling is stopped.

When used in a drilling fluid, the biomass may operate to occlude pores in the formation, and to form or promote the formation of a filter cake.

In various embodiments, the fluid is a production fluid and the biomass serves to inhibit corrosion, separate hydrocarbons from water, inhibit the formation of scale, paraffin, or corrosion (e.g., metal oxides), or to enhance production of oil or natural gas from the well. In an embodiment, the biomass is used to stimulate methanogenesis of microbes in the well. The biomass may provide nutrients and/or bind inhibitors so as to increase production of natural gas in the well. In this embodiment, the well can be a coal seam having methane generating capacity. See, for example, US Patent Application Nos. 2004/0033557, 2012/0021495, 2011/0284215, US2010/0248322, 2010/0248321, 2010/0035309, and 2007/0248531.

In various embodiments, the fluid comprises a viscosifier. Suitable viscosifiers include, but are not limited to, an alginate polymer selected from the group consisting of sodium alginate, sodium calcium alginate, ammonium calcium alginate, ammonium alginate, potassium alginate, propyleneglycol alginate, and mixtures thereof. Other suitable viscosifiers include organophillic clay, polyacrylamide, xanthan gum, and mixtures of xanthan gum and a cellulose derivative, including those wherein the weight ratio of xanthan gum to cellulose derivative is in the range from about 80:20 to about 20:80, and wherein the cellulose derivative is selected from the group consisting of hydroxyethylcellulose, hydroxypropylcellulose, carboxymethylcellulose and mixtures thereof. Other suitable viscosifiers include a biopolymer produced by the action of bacteria, fungi, or other microorganisms on a suitable substrate.

Mixtures of a bentonitic clay and additives can also be used as viscosifiers. The additives used in such mixtures can comprise, for example: (a) a nonionic, water-soluble polysaccharide selected from the group consisting of a non-ionic, water-soluble cellulosic derivative and a non-ionic water-soluble guar derivative; (b) an anionic water-soluble polysaccharide selected from the group consisting of a carboxymethyl cellulose and Xanthomonas campestris polysaccharide or a combination thereof; (c) an intermediate molecular weight polyglycol, i.e., selected from the group consisting of polyethylene glycol, polypropylene glycol, and poly-(alkanediol), having an average molecular weight of from about 600 to about 30,000; and (5) compatible mixtures thereof. Components of the mixtures may be added individually to the fluid to enhance the low shear rate viscosity thereof.

Aphrons can be used as additives to drilling fluids and other fluids used in creating or maintaining a borehole. Aphrons can concentrate at the fluid front and act as a fluid loss control agent and/or bridging agent to build an internal seal of the pore network along the side walls of a borehole. It is believed that aphrons deform during the process of sealing the pores and gaps encountered while drilling a borehole. Aphrons useful in the invention are typically 50-100 μM, 25-100 μM, 25-50 μM, 5-50, 5-25 μM, 7-15 μM or about 10 μM.

In one embodiment, a drilling fluid of the invention comprises aphrons, microbial biomass in which the oil has not been extracted (unextracted microbial biomass), spent biomass or a combination of aphrons, unextracted microbial biomass, and spent biomass.

Where an aphron is used, the aphron can have an average diameter of 5 to 50 micrometers and can make up about 0.001% to 5% by mass of the fluid.

In various embodiments, the fluid comprises a density modifier, also known as a weighting agent or a weighting additive. Suitable density modifiers include, but are not limited to, barite, hematite, manganese oxide, calcium carbonate, iron carbonate, iron oxide, lead sulfide, siderate, and ilmenite.

In various embodiments, the fluid comprises an emulsifier. Suitable emulsifiers may be nonionic, including ethoxylated alkylphenols and ethoxylated linear alcohols, or anionic, including alkylaryl sulfonates, alcohol ether sulfonates, alkyl amine sulfonates, petroleum sulfonates, and phosphate esters.

In various embodiments, the fluid comprises a lubricant. Non-limiting, suitable lubricants may include fatty acids, tall oil, sulphonated detergents, phosphate esters, alkanolamides, asphalt sulfonates, graphite, and glass beads.

The fluid can be a drilling fluid with a low shear rate viscosity as measured with a Brookfield viscometer at 0.5 rpm of at least 20,000 centipoise. In some embodiments, the low shear rate viscosity is at least about 40,000 centipoise.

Drilling fluids of the invention include any known drilling fluid in which one or more fluid loss control agents of that fluid is replaced, in whole or in part, by oleaginous microbial biomass or spent biomass derived therefrom. Illustrative known drilling fluids include those marketed by M-I SWACO, including the water-based systems marketed under the tradenames DRILPLEX, DURATHERM, ENVIROTHERM NT, GLYDRIL, K-MAG, KLA-SHIELD, POLY-PLUS, SAGDRIL, SILDRIL, and ULTRADRIL; the oil-based systems marketed under the tradenames MEGADRIL, VERSACLEAN, VERSADRIL, and WARP Fluids Technology; and the synthetic-based systems marketed under the tradenames ECOGREEN, NOVAPLUS, PARADRIL, PARALAND, PARATHERM, RHELIANT, and TRUDRIL. Other illustrative drilling fluids include those marketed by Halliburton, including the water-based systems marketed under the tradenames HYDRO-GUARD clay free System; PERFORMADRIL water-based drilling system; and SHALEDRIL water-based drilling system; and the invert emulsion drilling fluid systems ACCOLADE, ENCORE, INNOVERT, INTEGRADE, INVERMUL, and ENVIROMUL. Additional illustrative drilling fluids include those marketed by MASI Technologies LLC, including systems marketed under the tradenames APHRON ICS and POLYPHRON ICS as well as drilling fluid additives marketed by ARC Fluid Technologies.

The biomass added to fluid can be chemically modified prior to use. Chemical modification involves the formation or breaking of covalent bonds. For example, the biomass may be chemically modified by transesterification, saponification, crosslinking or hydrolysis. The biomass may be treated with one or more reactive species so as to attach desired moieties. The moieties may be hydrophobic, hydrophilic, amphiphilic, ionic, or zwitterionic. For example, the biomass may anionized (e.g., carboxymethylated), or acetylated. Methods for covalent modification including carboxymethylation and acetylation of biomass from oleaginous microbes are disclosed in U.S. Provisional Patent Application No. 61/615,832, filed on Mar. 26, 2012 for “Algal Plastics and Absorbants”, incorporated herein by reference in relevant part. U.S. Pat. No. 3,795,670 describes an acetylation process that can be used to increase the hydrophobicity of the biomass by reaction with acetic anhydride. Carboxymethylation of the biomass can be performed by treatment with monochloroacetic acid. See, e.g., U.S. Pat. No. 3,284,441. U.S. Pat. Nos. 2,639,239; 3,723,413; 3,345,358; 4,689,408, 6,765,042, and 7,485,719, which disclose methods for anionizing and/or cross-linking

The fluid can include one or more additives such as bentonite, xanthan gum, guar gum, starch, carboxymethylcellulose, hydroxyethyl cellulose, polyanionic cellulose, a biocide, a pH adjusting agent, polyacrylamide, an oxygen scavenger, a hydrogen sulfide scavenger, a foamer, a demulsifier, a corrosion inhibitor, a clay control agent, a dispersant, a flocculant, a friction reducer, a bridging agent, a lubricant, a viscosifier, a salt, a surfactant, an acid, a fluid loss control additive, a gas, an emulsifier, a density modifier, diesel fuel, and an aphron.

Fluids may be mixed or sheared for times appropriate to achieve a homogenous mixture.

Fluids may be subject to aging prior to testing or use. Aging may be performed under conditions that vary from static to dynamic and from ambient (20-25° C.) to highly elevated temperatures (>250° C.).

Preferably, the fluid made with the biomass of the oleaginous microbe is a non-Newtonian fluid. In a more specific embodiment, the fluid is characterized by pseudoplastic behavior. It is believed that the biomass causes a deviation from Newtonian behavior. Fluids can be described as Newtonian or non-Newtonian depending on their response to shearing. The shear stress of a Newtonian fluid is proportional to the shear rate. For non-Newtonian fluids, viscosity decreases as shear rate increases. One classification of non-Newtonian fluid behavior, pseudoplastic behavior, refers to a general type of shear-thinning that may be desirable for drilling fluids. Several mathematical models known in that art have been developed to describe the shear stress/shear rate relationship of non-Newtonian fluids. These models, including the Bingham plastic model, the Power Law model, and the Herschel-Buckley Model are described in “The Drilling Fluids Processing Handbook, Shale Shaker Committee of the American Society of Mechanical Engineers eds, Gulf Professional Publishing, 2004”. Additionally, see reference manuals including “Drilling Fluids Reference Manual, 2006” available from Baker Hughes.

In an embodiment, a method includes using the fluid with the biomass for creating a wellbore, maintaining, or producing a production fluid (e.g., petroleum oil, natural gas, or geothermal heat). Embodiments of the present invention also provide processes that include using the fluid with the biomass for a well servicing operation such as completion operations, sand control operations, workover operations, and hydraulic fracturing operations. In a specific embodiment, a method includes drilling a wellbore, wherein the drilling fluid is a drilling fluid of the invention and is continuously re-circulated into the wellbore while drilling proceeds.

The present invention also provides processes for conducting well servicing operations within a wellbore, wherein the well-servicing fluid is a drilling fluid of the invention. Well servicing operations include, for example, completion operations, sand control operations, workover operations, and frac pack operations.

Tests: The rheological characteristics of the fluids referred to in the following examples were determined using procedures set forth in the American Petroleum Institute's Specification for Oil Well Drilling-Fluid Materials, API Spec 13A and in the API publication, “Recommended Practice: Standard Procedure for Field Testing Water-Based (Oil-Based) Drilling Fluids,” API RP 13B-1, 13B-2, and supplements. Also see API RP 13I, Recommended Practice for Laboratory Testing of Drilling Fluids.

In these examples, a FANN® Model 35 viscometer of the Couette type, a FANN® Model ix77 rheometer, or a Chandler 3500LS viscometer was used to measure viscosity. Other viscometer types, including a capillary viscometer or a cone-and-plate viscometer are suitable for measuring viscosity and flow parameters of a fluid. In the case of measurements made with a FANN® viscometer or rheometer, dial readings of 600, 300, 200, 100, 6, and 3 rpm were recorded. Plastic viscosity (Pv) and yield point (YP) were calculated. Pv was determined by subtracting the 300-rpm reading from the 600-rpm reading. YP was determined by subtracting the Pv value from the 300-rpm reading. Gel strength measurements of fluids were recorded at 10-second (initial gel) and 10-minute gel intervals using a viscometer as per standard API recommended practice.

Fluid loss properties of fluids prepared with biomass samples referred to in Examples 9, 10, and 12-15 were determined using the API static filtration test procedure described in the API Specification 13A and the API RP 131, Recommended Practice for Laboratory Testing of Drilling Fluids. Testing was conducted at ambient temperatures. The sample was placed in a filter press cell atop a single layer of filter paper (such as Whatman No. 50 or equivalent). 100 psi was applied to the top of the filter cell. The volume (in cubic centimeters) of filtrate that passed through the filter paper was measured after the designated times of 7.5 minutes and at 30 minutes. The lower the volume of filtrate, the more effective the fluid formulation at preventing fluid loss. Similarly, the lower the volume of filtrate, the greater the fluid loss control exhibited by the fluid formulation.

Example 17 describes results of fluid loss tests performed at 120° F. In this example, samples were placed in a filter press cell atop a ceramic disc of known mass and length. 100 psi was applied to the top of the filter cell. The volume (in cubic centimeters) of filtrate that passed through the ceramic disc was measured for both instantaneous loss (spurt volume) and for total fluid loss that occurred after 60 minutes.

In certain embodiments, fluids including the oleaginous microbial biomass described herein have a reduced API Fluid loss test, as compared to fluids lacking this biomass. Illustrative fluids can have a reduction in fluid loss of greater than 2-, 5-, or 10-fold, relative to a control fluid lacking oleaginous microbial biomass according to the API Fluid Loss test for a duration of either 7.5 or 30 minutes. Alternatively, or additionally, fluids including the oleaginous microbial biomass can have 2-fold, 5-fold, 10-fold or greater increase in yield point, relative to a control fluid lacking this biomass, as measured using a Couette type viscometer. Alternatively, or in addition to any of these characteristics, fluids including the oleaginous microbial biomass can have an at least 2-fold reduction in spurt loss volume, relative to a control fluid lacking this biomass, as measured according to a static fluid loss test performed with a ceramic disc filter. Alternatively, or in addition to any of these characteristics, fluids including the oleaginous microbial biomass can have an at least 2-fold decrease in total fluid loss volume, relative to a control fluid lacking this biomass as measured according to a static fluid loss test performed with a ceramic disc. Static loss tests can be performed using ceramic discs having, e.g., a pore size of 5 microns, 10 microns, or 20 microns. In certain embodiments, the reduction in spurt loss volume or total fluid loss vulume is measured in the static fluid loss test after a duration of 30 minutes or 60 minutes. Alternatively, or in addition to any of these characteristics, fluids including the oleaginous microbial biomass can have an at least 2 fold increase in gel strength, relative to a control fluid lacking this biomass, according to a gel strength test performed with a Couette type viscometer. In particular embodiments, the gel strength test is performed for a duration of 7.5 minutes or 30 minutes. Alternatively, or in addition to any of these characteristics, fluids including the oleaginous microbial biomass can have a higher calculated viscosity after aging at a temperature of between 18° C. and 200° C. for at least 16 hours, than prior to aging, when measured at a shear rate between 0.01/sec and 1000/sec.

Certain aspects and embodiments of the invention are illustrated by the following examples.

### Example 1

### Cultivation of Microalgae to Achieve High Oil Content

Microalgae strains were cultivated to achieve a high percentage of oil by dry cell weight. Cryopreserved cells were thawed at room temperature, and 500 μl of cells were added to 4.5 ml of medium (4.2 g/L K₂HPO₄, 3.1 g/L NaH₂PO₄, 0.24 g/L MgSO₄.7H₂O, 0.25 g/L citric acid monohydrate, 0.025 g/L CaCl₂ 2H₂O, 2 g/L yeast extract) plus 2% glucose and grown for 7 days at 28° C. with agitation (200 rpm) in a E-well plate. Dry cell weights were determined by centrifuging 1 ml of culture at 14,000 rpm for 5 minutes in a pre-weighed Eppendorf tube. The culture supernatant was discarded and the resulting cell pellet washed with 1 ml of deionized water. The culture was again centrifuged, the supernatant discarded, and the cell pellets placed at −80° C. until frozen. Samples were then lyophilized for 24 hours and dry cell weights were calculated. For determination of total lipid in cultures, 3 ml of culture was removed and subjected to analysis using an Ankom system (Ankom Inc., Macedon, N.Y.) according to the manufacturer's protocol. Samples were subjected to solvent extraction with an Ankom XT10 extractor according to the manufacturer's protocol. Total lipid was determined as the difference in mass between acid hydrolyzed dried samples and solvent extracted, dried samples. Percent oil dry cell weight measurements are shown below in Table 5.

TABLE 5
Cultivation of microalgae to achieve high oil content.

| Species | Strain | % Oil |
|---|---|---|
| Chlorella kessleri | UTEX 397 | 39.42 |
| Chlorella kessleri | UTEX 2229 | 54.07 |
| Chlorella kessleri | UTEX 398 | 41.67 |
| Parachlorella kessleri | SAG 11.80 | 37.78 |
| Parachlorella kessleri | SAG 14.82 | 50.70 |
| Parachlorella kessleri | SAG 21.11 H9 | 37.92 |
| Prototheca stagnora | UTEX 327 | 13.14 |
| Prototheca moriformis | UTEX 1441 | 18.02 |
| Prototheca moriformis | UTEX 1435 | 27.17 |
| Chlorella minutissima | UTEX 2341 | 31.39 |
| Chlorella protothecoides | UTEX 250 | 34.24 |
| Chlorella protothecoides | UTEX 25 | 40.00 |
| Chlorella protothecoides | CCAP 211/8D | 47.56 |
| Chlorella sp. | UTEX 2068 | 45.32 |
| Chlorella sp. | CCAP 211/92 | 46.51 |
| Chlorella sorokiniana | SAG 211.40B | 46.67 |
| Parachlorella beijerinkii | SAG 2046 | 30.98 |
| Chlorella luteoviridis | SAG 2203 | 37.88 |
| Chlorella vulgaris | CCAP 211/11K | 35.85 |
| Chlorella reisiglii | CCAP 11/8 | 31.17 |
| Chlorella ellipsoidea | CCAP 211/42 | 32.93 |
| Chlorella saccharophila | CCAP 211/31 | 34.84 |
| Chlorella saccharophila | CCAP 211/32 | 30.51 |

Culturing Chlorella protothecoides to Achieve High Oil Content

Three fermentation processes were performed with three different media formulations with the goal of generating algal biomass with high oil content. The first formulation (Media 1) was based on medium described in Wu et al. (1994 Science in China, vol. 37, No. 3, pp. 326-335) and consisted of per liter: KH₂PO₄, 0.7 g; K₂HPO₄, 0.3 g; MgSO₄-7H₂O, 0.3 g; FeSO₄-7H₂O, 3 mg; thiamine hydrochloride, 10 μg; glucose, 20 g; glycine, 0.1 g; H₃BO₃, 2.9 mg; MnCl₂-4H₂O, 1.8 mg; ZnSO₄.7H₂O, 220 μg; CuSO₄-5H₂O, 80 μg; and NaMoO₄-2H₂O, 22.9 mg. The second medium (Media 2) was derived from the flask media described in Example 1 and consisted of per liter: K₂HPO₄, 4.2 g; NaH₂PO₄, 3.1 g; MgSO₄.7H₂O, 0.24 g; citric acid monohydrate, 0.25 g; calcium chloride dehydrate, 25 mg; glucose, 20 g; yeast extract, 2 g. The third medium (Media 3) was a hybrid and consisted of per liter: K₂HPO₄, 4.2 g; NaH₂PO₄, 3.1 g; MgSO₄-7H₂O, 0.24 g; citric acid monohydrate, 0.25 g; calcium chloride dehydrate, 25 mg; glucose, 20 g; yeast extract, 2 g; H₃BO₃, 2.9 mg; MnCl₂-4H₂O, 1.8 mg; ZnSO₄.7H₂O, 220 μg; CuSO₄-5H₂O, 80 μg; and NaMoO₄-2H₂O, 22.9 mg. All three media formulations were prepared and autoclave sterilized in lab scale fermentor vessels for 30 minutes at 121° C. Sterile glucose was added to each vessel following cool down post autoclave sterilization.

Inoculum for each fermentor was Chlorella protothecoides (UTEX 250), prepared in two flask stages using the medium and temperature conditions of the fermentor inoculated. Each fermentor was inoculated with 10% (v/v) mid-log culture. The three lab scale fermentors were held at 28° C. for the duration of the experiment. The microalgal cell growth in Media 1 was also evaluated at a temperature of 23° C. For all fermentor evaluations, pH was maintained at 6.6-6.8, agitations at 500 rpm, and airflow at 1 vvm. Fermentation cultures were cultivated for 11 days. Biomass accumulation was measured by optical density at 750 nm and dry cell weight.

Lipid/oil concentration was determined using direct transesterification with standard gas chromatography methods. Briefly, samples of fermentation broth with biomass was blotted onto blotting paper and transferred to centrifuge tubes and dried in a vacuum oven at 65-70° C. for 1 hour. When the samples were dried, 2 mL of 5% H₂SO₄ in methanol was added to the tubes. The tubes were then heated on a heat block at 65-70° C. for 3.5 hours, while being vortexed and sonicated intermittently. 2 ml of heptane was then added and the tubes were shaken vigorously. 2 Ml of 6% K₂CO₃ was added and the tubes were shaken vigorously to mix and then centrifuged at 800 rpm for 2 minutes. The supernatant was then transferred to GC vials containing Na₂SO₄ drying agent and ran using standard gas chromatography methods. Percent oil/lipid was based on a dry cell weight basis. The dry cell weights for cells grown using: Media 1 at 23° C. was 9.4 g/L; Media 1 at 28° C. was 1.0 g/L, Media 2 at 28° C. was 21.2 g/L; and Media 3 at 28° C. was 21.5 g/L. The lipid/oil concentration for cells grown using: Media 1 at 23° C. was 3 g/L; Media 1 at 28° C. was 0.4 g/L; Media 2 at 28° C. was 18 g/L; and Media 3 at 28° C. was 19 g/L. The percent oil based on dry cell weight for cells grown using: Media 1 at 23° C. was 32%; Media 1 at 28° C. was 40%; Media 2 at 28° C. was 85%; and Media 3 at 28° C. was 88%.

### Example 2

### Culturing Oleaginous Yeast To Achieve High Oil Content

Yeast strain Rhodotorula glutinis (DSMZ-DSM 70398) was obtained from the Deutsche Sammlung von Mikroorganismen and Zellkulturen GmbH (German Collection of Microorganism and Cell Culture, Inhoffenstraβe 7B, 38124 Braunschweig, Germany). Cryopreserved cells were thawed and added to 50 mL YPD media (described above) with 1×DAS vitamin solution (1000×: 9 g/L tricine; 0.67 g/L thiamine-HCl; 0.01 g/L d-biotin; 0.008 cyannocobalamin; 0.02 calcium pantothenate; and 0.04 g/L p-Aminobenzoic acid) and grown at 30° C. with 200 rpm agitation for 18-24 hours until an OD reading was over 5 OD (A600). The culture was then transferred to 7-L fermentors and switched to YP1 medium (8.5 g/L Difco Yeast Nitrogen Base without Amino Acids and Ammonium Sulfate, 3 g/L Ammonium Sulfate, 4 g/L yeast extract) with 1×DAS vitamin solution. The cultures were sampled twice per day and assayed for OD (A600), dry cell weight (DCW) and lipid concentration. When the cultures reached over 50 g/L DCW, the cultures were harvested. Based on dry cell weight, the yeast biomass contained approximately 50% oil.

Oleaginous yeast strains used in this example were obtained from either the Deutsche Sammlung von Mikroorganismen un Zellkulturen GmbH (DSMZ), located at Inhoffenstrabe 7B, 38124 Braunschweig, Germany, or Centraalbureau voor Schimmelscultures (CBS) Fungal Biodiversity Centre located at P.O. Box 85167, 3508 Utrecht, the Netherlands. One hundred eighty five oleaginous yeast strains were screened for growth rate and lipid production.

All strains were rendered axenic via streaking to single colonies on YPD agar (YPD medium as described below with 2% agar added) plates. Single colonies from the YPD plates of each strain was picked and grown to late log phase in YPD medium (10 g bacto-yeast extract, 20 g bacto-peptone and 20 g glucose/1 L final volume in distilled water) on a rotary shaker at 200 rpm at 30° C.

For lipid productivity assessment, 2 mL of YPD medium was added to a 50 mL tared Bioreactor tube (MidSci, Inc.) and inoculated from a frozen stock of each strain. The tubes were then placed in a 30° C. incubator and grown for 24 hours, shaking at 200 rpm to generate a seed culture. After 24 hours, 8 mLs of Yl medium (Yeast nitrogen base without amino acids, Difco) containing 0.1M phthalate buffer, pH 5.0 was added and mixed well by pipetting gently. The resulting culture was divided equally into a second, tared bioreactor tube. The resulting duplicate cultures of 5 mL each were then placed in a 30° C. incubator with 200 rpm agitation for 5 days. The cells were then harvested for lipid productivity and lipid profile. 3 mL of the culture was used for determination of dry cell weight and total lipid content (lipid productivity) and 1 mL was used for fatty acid profile determination. In either case, the cultures were placed into tubes and centrifuged at 3500 rpm for 10 minutes in order to pellet the cells. After decanting the supernatant, 2 mL of deionized water was added to each tube and used to wash the resulting cell pellet. The tubes were spun again at 3500 rpm for 10 minutes to pellet the washed cells, the supernatant was then decanted and the cell pellets were placed in a −70° C. freezer for 30 minutes. The tubes were then transferred into a lyophilizer overnight to dry. The following day, the weight of the conical tube plus the dried biomass resulting from the 3 mL culture was recorded and the resulting cell pellet was subjected to total lipid extraction using an Ankom Acid Hydrolysis system (according to the manufacturer's instructions) to determine total lipid content.

Of the 185 strains screened, 30 strains were chosen based on the growth rate and lipid productivity. The lipid productivity (expressed as percent lipid of dry cell weight) of these 30 strains are summarized in the table below.

Lipid productivity of oleaginous yeast strains.

| | | % Lipid |
|---|---|---|
| Species | Collection No. | (DCW) |
| Rhodotorula terpenoidalis | CBS 8445 | 27 |
| Rhodotorula glutinus | DSMZ 70398 | 53.18 |
| Lipomyces tetrasporous | CBS 1810 | 51 |
| Lipomyces tetrasporous | CBS 7656 | 17.63 |
| Lipomyces tetrasporous | CBS 8724 | 18 |
| Cryptococcus curvatus | CBS 5324 | 53 |
| Cryptococcus curvatus | CBS 2755 | 48 |
| Rhodosporidium sphaerocarpum | CBS 2371 | 43 |
| Rhodotorula glutinus | CBS 4476 | 30.97 |
| Lipomyces tetrasporous | CBS 1808 | 29 |
| Trichosporon domesticum | CBS 8111 | 35.16 |
| Trichosporon sp. | CBS 7617 | 40.09 |
| Lipomyces tetrasporous | CBS 5911 | 27.63 |
| Lipomyces tetrasporous | CBS 5607 | 12.81 |
| Cryptococcus curvatus | CBS 570 | 38.64 |
| Cryptococcus curvatus | CBS 2176 | 40.57 |
| Cryptococcus curvatus | CBS 5163 | 35.26 |
| Torulaspora delbruekii | CBS 2924 | 40.00 |
| Rhodotorula toruloides | CBS 8761 | 36.52 |
| Geotrichum histeridarum | CBS 9892 | 33.77 |
| Yarrowia lipolytica | CBS 6012 | 29.21 |
| Geotrichum vulgare | CBS 10073 | 28.04 |
| Trichosporon montevideense | CBS 8261 | 25.60 |
| Lipomyces starkeyi | CBS 7786 | 25.43 |
| Trichosporon behrend | CBS 5581 | 23.93 |
| Trichosporon loubieri var. loubieri | CBS 8265 | 22.39 |
| Rhodosporidium toruloides | CBS 14 | 21.03 |
| Trichosporon brassicae | CBS 6382 | 20.34 |
| Rhodotorula aurantiaca | CBS 317 | 17.51 |
| Sporobolomyces alborubescens | CBS 482 | 10.09 |

### Example 3

### Cultivation of Rhodococcus opacus to Achieve High Oil Content

A seed culture of Rhodococcus opacus PD630 (DSM 44193, Deutsche Sammlung von Mikroorganismen and Zellkuttwen GmbH) was generated using 2 ml of a cryo-preserved stock inoculated into 50 ml of MSM media with 4% sucrose (see Schlegel, et al., (1961) Arch Mikrobiol 38, 209-22) in a 250 ml baffle flask. The seed culture was grown at 30° C. with 200 rpm agitation until it reached an optical density of 1.16 at 600 nm. 10 ml of the seed flask was used to inoculate cultures for lipid production under two different nitrogen conditions: 10 mM NH₄Cl and 18.7 mM NH₄Cl (each in duplicate). The growth cultures were grown at 30° C. with 200 rpm agitation for 6 days. Cells grown in the 10 mM NH₄Cl condition reached a maximal 57.2% (average) lipid by DCW after 6 days of culture. Cells grown in the 18.7 mM NH₄Cl condition reached a maximal 51.8% (average) lipid by DCW after 5 days in culture.

### Example 4

### Preparation of Spent Biomass from Microalgae

Methods of oil extraction from microalgae, and thereby producing spent biomass, using a oil-seed press is described in detail in PCT application number PCT/US10/031,108, hereby incorporated by this reference. In brief, Prototheca moriformis (UTEX 1435) containing approximately 66% oil (by dry cell weight) was drum dried to a moisture content of about 2.7%. The dried biomass was then heat-conditioned in a vertical stacked heat conditioner. The moisture content of the biomass after heat-conditioning was approximately 0.6-1.4%. The algal biomass was then fed into a 3.5″ oil seed screw press (French Oil Mill Company, Piqua Ohio) with the cage preheated to 195-220° F. The biomass oiled well with some footing. The spent biomass was then collected and was suitable for use in the methods of the invention.

Chlorella protothecoides (UTEX 250) containing approximately 38% oil (by dry cell weight) was drum dried to a moisture content of about 3 to 5%. The dried biomass was then heat-conditioned in a vertical stacked heat conditioner at 250° F. The algal biomass was then fed into a 3.5″ oil seed screw press (French Oil Mill Company, Piqua Ohio) with the cage preheated to about 200° F. The biomass oiled well with some footing. The spent biomass was then collected and was suitable for use in the methods of the invention.

Similar generation of spent biomass with dried microalgal biomass combined with 5 to 20% press aids such as switchgrass and soy hulls was performed. Microalgal biomass (Chlorella protothecoides UTEX 250) containing 38% oil by DCW was dried using a drum dryer with a resulting moisture content of about 3.5% (as measured by a moisture analyzer). Five to 20% (w/w) of dried switchgrass or soyhulls were combined with the drum dried microalgal biomass. The biomass was then heat conditioned in a vertical stacked heat conditioner in similar conditions as described above. The heat conditioned biomass was then fed into an L-250 (3.5″ diameter) French pilot scale oilseed screw press (French Oil Mill Machinery Company, Piqua, Ohio) with core main barrel (or cage) had a diameter of 3.5 inches. The cage and shaft was preheated to between 180° F. and 260° F. by using indirect steam. The biomass oiled well with some footing. The spent biomass (which included the addition of dried switchgrass or soyhulls) were then collected and were suitable for use in the methods of the invention.

### Example 5

### Preparation of Spent Biomass from Oleaginous Yeast by Mechanical Extraction

Yeast strain Rhodotorula glutinis (DSMZ-DSM 70398) was obtained from the Deutsche Sammlung von Mikroorganismen and Zellkulturen GmbH (German Collection of Microorganism and Cell Culture, Inhoffenstraβe 7B, 38124 Braunschweig, Germany. Cryopreserved cells were thawed and added to 50 mL YPD media (described above) with 1×DAS vitamin solution (1000×: 9 g/L tricine; 0.67 g/L thiamine-HCl; 0.01 g/L d-biotin; 0.008 cyannocobalamin; 0.02 calcium pantothenate; and 0.04 g/L p-Aminobenzoic acid) and grown at 30° C. with 200 rpm agitation for 18-24 hours until an OD reading was over 5 OD (A600). The culture was then transferred to 7-L fermentors and switched to YP1 medium (8.5 g/L Difco Yeast Nitrogen Base without Amino Acids and Ammonium Sulfate, 3 g/L Ammonium Sulfate, 4 g/L yeast extract) with 1×DAS vitamin solution. The cultures were sampled twice per day and assayed for OD (A600), dry cell weight (DCW) and lipid concentration. When the cultures reached over 50 g/L DCW, the cultures were harvested. Based on dry cell weight, the yeast biomass contained approximately 50% oil.

The harvested yeast broth was dried using three different methods for comparison: (1) tray dried in a forced air oven at 75° C. overnight; (2) dried on a drum dryer without concentration; and (3) the yeast broth was concentrated to 22% solids and the slurry was then dried on a drum dryer. Material from each of the three different drying conditions was heat conditioned and fed through a screw press for oil extraction. The press temperature was at 150° F. and the conditioned dried yeast biomass was held at about 190° F. until it was ready to be fed into the press.

The moisture content of the tray dried yeast was 1.45% and the dried yeast was then conditioned in an oven at 90° C. for 10 minutes. The moisture content after conditioning was 0.9%. The conditioned tray dried material was then fed into a bench-top Taby screw press (Taby Pressen Type 70 oil press with a 2.2 Hp motor and 70 mm screw diameter) for oil extraction. This material did not yield any significant amount of oil and heavy footing was observed with the press.

The moisture content of the drum dried yeast broth without concentration was 5.4% and the drum dried yeast was then conditioned in an oven at 90° C. for 20 minutes. The moisture content after conditioning was 1.4%. The conditioned drum dried yeast was then fed into a bench-top Taby screw press for oil extraction. This material oiled well, with minimal footing.

The moisture content of the drum dried concentrated yeast broth was 2.1% and the drum dried concentrated yeast was then conditioned in an oven at 90° C. for 20 minutes. The moisture content after conditioning was 1.0%. The conditioned drum dried concentrated yeast was then fed into a bench-top Taby screw press for oil extraction. This material oiled well, with minimal footing, creating spent biomass suitable for use as a fluid loss control agent.

### Example 6

### Drying and Oil Extraction from Oleaginous Bacteria

Oleaginous bacteria strain Rhodococcus opacus PD630 (DSMZ-DSM 44193) was cultured according to the methods in Example 1 to produce oleaginous bacteria biomass with approximately 32% lipid by DCW.

The harvested Rhodococcus opacus broth was concentrated using centrifugation and then washed with deionized water and resuspended in 1.8 L of deionized water. 50 grams of purified cellulose (PB20-Pre-co-Floc, EP Minerals, Nevada) was added to the resuspended biomass and the total solids was adjusted with deionized water to 20%. The Rhodococcus biomass was then dried on a drum drier and the moisture content of the Rhodococcus after drum drying was approximately 3%.

The drum-dried material was then heat conditioned in a oven at 130° C. for 30 minutes with a resulting moisture content of approximately 1.2%. The heat conditioned biomass was then fed through a bench top Taby press (screw press) for oil extraction. The press temperature was at 209° F. and the conditioned dried yeast biomass was held at about 240° F. until it was ready to be fed into the press. Oil recovery was accompanied by heavy footing, creating spent biomass suitable for use in the compositions of the invention.

### Example 7

### Analysis of Spent Biomass

Spent biomass from Prototheca moriformis (UTEX 1435) generated according to the methods described above was subjected to proximate analysis using standard AOAC methods. The results were: 4.21% moisture; 8.9% crude protein; 9.01% fat (by acid hydrolysis); 7.11% ash; and no detectable levels of non-protein nitrogen. The spent biomass was also subjected to amino acid profile analysis using standard methods. The normalized amino acid distribution was the following: methionine (3.19); cystine (2.64); lysine (1.81); phenylalanine (4.86); leucine (9.03); isoleucine (4.31); threonine (6.25); valine (5.97); histidine (1.67); arginine (5.00); glycine (5.83); aspartic acid (8.61); serine (7.08); glutamic acid (11.25); proline (6.11); hydroxyproline (3.61); alanine (8.75); tyrosine (3.33); and tryptophan (0.69).

Dried biomass from Chlorella protothecoides (UTEX 250) was subjected to a series of analytical analysis. Aqueous solution of 80% ethanol soluble extract determination of sugars by HPLC was included in the analytical analysis. Four different lots of dried biomass were analyzed and compared to sucrose, glucose and fructose standard. In all four lots, only sucrose was detected in the following percentages: 5.47%; 4.72%; 7.35%; and 4.86%.

Analysis of fiber content on dried biomass containing either 30-40% lipid by dry cell weight or 45-46% protein was performed using AOAC Methods 985.29 and 911.43 In the biomass containing 30-40% lipid by dry cell weight, 4.70-6.51% of insoluble fiber; 20.68%-32.02% soluble fiber; and 27.19-36.72% total dietary fiber was detected. In the biomass containing 45-46% protein, 22.73-23.44% insoluble fiber; 6.82-9.85% soluble fiber; and 30.26-32.57% total dietary fiber was detected. The dried biomass were then subjected to further monosaccharide analysis. The results from both acid soluble hydrolysates determination of sugars by gas chromatography of the biomass and determination of sugars by gas chromatography on the insoluble and soluble dietary samples from the biomass are summarized below. For the biomass samples, sugars were determined as alditol acetate derivatives and the monosaccharides were found in carbohydrate polymers present in the extracted material. In addition to the listed monosaccharides below in Table 7, a significant number of unidentified non-neutral sugars were detected.

TABLE 7
Determination of Sugars

| | | | | | |
|---|---|---|---|---|---|
| Sample | arabinose | Xylose | mannose | galactose | glucose |

Acid Soluble Hydrolysates Determination of Sugars
by GC of the Algal Biomass

| | | | | | |
|---|---|---|---|---|---|
| lipid 1 | 8.8 | 13.5 | 38.1 | 20.8 | 18.6 |
| lipid 2 | 4.0 | 16.4 | 39.7 | 28.5 | 11.4 |
| protein 1 | 7.3 | 9.3 | 20.7 | 36.9 | 25.8 |
| protein 2 | 7.3 | 5.7 | 31.0 | 39.0 | 17.0 |

Determination of Sugars by GC on Insoluble and Soluble Fiber Samples

| | | | | | |
|---|---|---|---|---|---|
| Insoluble | | | | | |
| lipid 1 | 5.1 | NA | NA | 76.7 | 18.2 |
| lipid 2 | 16.5 | 13.2 | 34.6 | 21.5 | 14.3 |
| protein 1 | 6.7 | 11.0 | 42.7 | 22.3 | 17.3 |
| protein 2 | 10.4 | 9.9 | 34.2 | 33.8 | 11.6 |
| Soluble | | | | | |
| lipid 1 | 4.5 | NA | 7.9 | 52.7 | 34.9 |
| lipid 2 | 3.2 | 3.7 | 36.1 | 18.5 | 38.5 |
| protein 1 | NA | NA | 48.5 | NA | 51.5 |
| protein 2 | 13.7 | NA | 17.6 | NA | 68.7 |

Defatted algal biomass from Chlorella protothecoides (UTEX 250) were subjected to 80% ethanol treatment and then analyzed for carbohydrate percentage. The results from this analysis are summarized below:

Soluble Extract

| Sample | % Solids | Dried % | Carbohydrate % |
|---|---|---|---|
| lipid 1 | 30.14 | 18.63 | 11.64 |
| protein 1 | 36.88 | 22.40 | 13.53 |

### Example 8

### Preparation of Microalgal Biomass

Dried, spent microalgal biomass from cultivation of the obligate heterotroph, Prototheca moriformis (UTEX 1435) was prepared according to methods given in Example 4, Example 7, and described in detail in PCT application number PCT/US 10/031,108. Dried, spent Prototheca moriformis (UTEX 1435) biomass comprising 2-10% oil was subjected to various physical manipulations prior to inclusion in fluid preparations.

Spent microalgal biomass described in Examples 9-14 were prepared with biomass that was first fragmented by percussion with a hammer, then ground in a ball mill. The resulting ground material was sieved using a USA Standard Test Sieve No. 100 sieve (150 microns). Ground biomass particles smaller than 150 microns were used in fluid preparations. Biomass particles larger than 150 microns were reground until a particle size of less than 150 microns was achieved.

Fluids comprising microalgal biomass described in Examples 15 and 16 were prepared with spent microalgal biomass that was first ground in a Waring blender. The resulting ground material was sieved using a USA Standard Test Sieve No. 40 sieve (425 microns). Ground biomass particles smaller than 425 microns were used in fluid preparations.

### Example 9

### Rheology and API Fluid Loss Measurements of Fluids Prepared with KCl and Microalgal Biomass

In this example, water-based fluids comprising spent Prototheca moriformis (UTEX 1435) biomass of Example 8 were evaluated for rheological and fluid loss properties. Sample fluid compositions A-L were prepared by mixing 350 mL water, 2% KCl (w/v), 0.15% xanthan gum (w/v), the type and percent (w/v) of a oil field chemical indicated in Table 9, and the type and percent (w/v) of dried, spent microalgal biomass indicated in Table 8. Oil field chemicals included carboxymethyl cellulose (CMC), starch, or bentonite. Samples were brought to a final pH of 8.0-9.0. Rheology measurements, recorded in Table 9 were made using a FANN® Model 35 viscometer at the rpm indicated. The API fluid loss test was conducted at ambient temperature. For each sample A-L, the volume of fluid passing through the filter after 7.5 minutes and 30 minutes is indicated in Table 9.

TABLE 8
Type and Amount of Biomass in water-based fluids

| | | Microalgal Biomass |
|---|---|---|
| Sample | Microalgal Biomass Type | (% w/v) |
| A, E, I | Spent microalgal biomass | 0.25 |
| B, F, J | Spent microalgal biomass, pressed | 0.25 |
| | with soy hulls at 15% | |
| C, G, K | Spent microalgal biomass | 3.0 |
| D, H, L | Spent microalgal biomass, pressed | 3.0 |
| | with soy hulls at 15% | |

TABLE 9
API fluid loss and rheology measurements performed on water-
based fluids comprising microalgal biomass

| | | | | | | | | | YP | API Fluid | |
|---|---|---|---|---|---|---|---|---|---|---|---|
| | Oil Field | | | | | | | Pv | lb/100 sq | Loss | |
| Sample | Chemical (w/v) | 600 rpm | 300 rpm | 200 rpm | 100 rpm | 6 rpm | 3 rpm | cP | ft | 7.5 min | 30 min |
| A | 0.45% CMC | 17 | 11 | 9 | 6 | 2 | 1 | 6 | 5 | 180 | 189 |
| B | | 17 | 11 | 9 | 6 | 2 | 1 | 6 | 5 | 255 | 261 |
| C | | 19 | 12 | 9 | 6 | 1 | 1 | 7 | 5 | 16 | 18 |
| D | | 24 | 15 | 11 | 7 | 2 | 1 | 9 | 6 | 8 | 11 |
| E | 0.3% STARCH | 3 | 2 | 1 | 1 | 1 | 0 | 1 | 1 | 35 | 41 |
| F | | 2 | 1 | 1 | 1 | 0 | 0 | 1 | 0 | 41 | 52 |
| G | | 4 | 2 | 2 | 1 | 0 | 0 | 2 | 0 | 8 | 12 |
| H | | 5 | 3 | 2 | 2 | 1 | 1 | 2 | 1 | 23 | 112 |
| I | 1.5% | 4 | 2 | 1 | 1 | 0 | 0 | 2 | 0 | 36 | 71 |
| J | BENTONITE | 3 | 2 | 2 | 1 | 1 | 0 | 1 | 1 | 41 | 88 |
| K | | 5 | 3 | 3 | 2 | 1 | 0 | 2 | 1 | 29 | 55 |
| L | | 5 | 3 | 2 | 1 | 1 | 0 | 2 | 1 | 31 | 62 |

The data presented in Table 9 demonstrate that the fluid loss control of water-based fluid samples prepared with microalgal biomass was improved with increased concentrations of microalgal biomass. Increasing the microalgal biomass percentage from 0.25% (Sample A) to 3.0% (Sample C) led to a decrease in fluid loss from 180 ml to 16 ml at 7.5 minutes and from 189 ml to 18 ml at 30 minutes, a >10-fold decrease in fluid loss. The water-based fluid sample prepared with CMC and 3.0% spent microalgal biomass pressed with soy hulls demonstrated >30-fold decrease in fluid loss at 7.5 minutes and >20-fold decrease in fluid loss at 30 minutes over the comparative fluid sample prepared with only 0.25% spent microalgal biomass pressed with soy hulls (compare Sample B to D). These data demonstrate that addition of spent microbial biomass improved the fluid loss control and to a decrease in fluid loss properties of water-based fluids comprising an oil field chemical.

### Example 10

### Rheology and API Fluid Loss Measurements of Fluids Prepared with Seawater and Microalgal Biomass

In this example, seawater-based fluids comprising spent Prototheca moriformis biomass of Example 8 were evaluated for rheological and fluid loss properties. Samples A-L were prepared by mixing 350 mL seawater, 0.15% xanthan gum (w/v), the type and percentage (w/v) of oil field chemical indicated in Table 11, and the type and percentage (w/v) of dried, spent microalgal biomass indicated in Table 10. Oil field chemicals included carboxymethyl cellulose (CMC), starch, or bentonite. Samples were brought to a final pH of 8.0-9.0. Rheology measurements, recorded in Table 11 were made using a FANN® Model 35 viscometer at the rpm indicated. The API fluid loss test was conducted at ambient temperature (20-25° C.). For each sample A-L, the volume of fluid passing through the filter after 7.5 minutes and 30 minutes is indicated in Table 11.

TABLE 10
Type and Concentration of Biomass in seawater-based fluids

| | | Microalgal Biomass |
|---|---|---|
| Sample | Microalgal Biomass Type | (% w/v) |
| A, E, I | Spent microalgal biomass | 0.25 |
| B, F, J | Spent microalgal biomass, pressed | 0.25 |
| | with soy hulls at 15% | |
| C, G, K | Spent microalgal biomass | 3.0 |
| D, H, L | Spent microalgal biomass, pressed | 3.0 |
| | with soy hulls at 15% | |

TABLE 11
API fluid loss and rheology measurements performed on
seawater based fluids comprising microalgal biomass

| | Oil Field | | | | | | | | YP | | |
|---|---|---|---|---|---|---|---|---|---|---|---|
| | Chemical | | | | | | | Pv | lb/100 sq | API Fluid Loss | |
| Sample | (w/v) | 600 rpm | 300 rpm | 200 rpm | 100 rpm | 6 rpm | 3 rpm | cP | ft | 7.5 min | 30 min |
| A | 0.45% CMC | 14 | 8 | 6 | 3 | 1 | 1 | 6 | 2 | 285 | 292 |
| B | | 14 | 8 | 6 | 3 | 1 | 1 | 6 | 2 | 205 | 211 |
| C | | 16 | 9 | 6 | 4 | 1 | 1 | 7 | 2 | 13 | 17 |
| D | | 24 | 14 | 11 | 6 | 1 | 1 | 10 | 4 | 21 | 25 |
| E | 0.3% | 2 | 1 | 1 | 0 | 0 | 0 | 1 | 1 | 33 | 43 |
| F | STARCH | 2 | 1 | 1 | 0 | 0 | 0 | 1 | 1 | 36 | 43 |
| G | | 4 | 2 | 2 | 1 | 0 | 0 | 2 | 0 | 7 | 11 |
| H | | 4 | 2 | 2 | 1 | 0 | 0 | 2 | 0 | 25 | 34 |
| I | 1.5% | 2 | 1 | 1 | 0 | 0 | 0 | 1 | 0 | 63 | 107 |
| J | BENTONITE | 2 | 1 | 1 | 0 | 0 | 0 | 1 | 0 | 74 | 137 |
| K | | 4 | 3 | 2 | 1 | 1 | 0 | 1 | 2 | 24 | 72 |
| L | | 4 | 2 | 1 | 1 | 0 | 0 | 2 | 0 | 37 | 78 |

The data presented in Table 11 demonstrate that the fluid loss control of seawater-based fluid samples prepared with microalgal biomass was improved with increased concentrations of microalgal biomass. Increasing the microalgal biomass from 0.25% (Sample A) to 3.0% (Sample C) led a decrease in fluid loss from 285 ml to 13 ml at 7.5 minutes and from 292 ml to 17 ml at 30 minutes, a >17-fold decrease in fluid loss. The seawater-based fluid sample prepared with CMC and 3.0% spent microalgal biomass pressed with soy hulls demonstrated >9-fold decrease in fluid loss at 7.5 minutes and >8-fold decrease in fluid loss at 30 minutes over the comparative fluid sample prepared with only 0.25% spent microalgal biomass pressed with soy hulls (compare Sample B to D). These data demonstrate that addition of spent microbial biomass improved the fluid loss control and a decrease in fluid loss of seawater-based fluids comprising an oil field chemical.

### Example 11

### Temperature Effects on the Rheology of Fluid Prepared with KCl and Microalgal Biomass

In this example, the impacts of temperature on the rheological properties of a water-based fluid comprising spent Prototheca moriformis (UTEX 1435) biomass of Example 8 were investigated. The fluid was prepared by mixing 350 mL water, 2% KCl (w/v), 0.15% xanthan gum (w/v), and 4% (w/v) dried, spent microalgal biomass. The sample was then heated from 60° C. to 140° C., held at 140° C. for 30 minutes, then cooled to 60° C. Rheology measurements, performed using a FANN® Model ix77 rheometer at the temperatures and rpm indicated in Table 12, were conducted on the sample at 20° C. increments along the temperature gradient. The resulting data are shown in Table 12.

TABLE 12
Temperature impacts on the rheology of water-based fluids
comprising microalgal biomass.

| Temper- | | | | | | | | YP |
|---|---|---|---|---|---|---|---|---|
| ature | 600 | 300 | 200 | 100 | | | Pv | lb/100 sq |
| ° C. | rpm | rpm | rpm | rpm | 6 rpm | 3 rpm | (cP) | ft |
| 60 | 15.1 | 9.9 | 8.4 | 6.5 | 3 | 2.6 | 5.2 | 4.7 |
| 80 | 12.8 | 8.6 | 7 | 5.5 | 2.6 | 2.4 | 4.2 | 4.4 |
| 100 | 10.9 | 7.2 | 5.9 | 4.5 | 2.4 | 2.2 | 3.7 | 3.5 |
| 120 | 7.8 | 4.9 | 4 | 3.1 | 2.2 | 2.1 | 2.9 | 2 |
| 140 | 3.8 | 2.6 | 2.3 | 2.2 | 2.2 | 2.2 | 1.2 | 1.4 |
| | Held at 140° C. for 30 minutes | | | | | | | |
| 120 | 4 | 2.7 | 2.5 | 2.4 | 2.3 | 2.2 | 1.3 | 1.4 |
| 100 | 5.9 | 3.7 | 3.1 | 2.7 | 2.2 | 2.2 | 2.2 | 1.5 |
| 80 | 7.2 | 4.4 | 3.7 | 3 | 2.2 | 2.2 | 2.8 | 1.6 |
| 60 | 8.9 | 5.5 | 4.3 | 3.4 | 2.2 | 2.2 | 3.4 | 2.1 |

The result of heating the prepared fluid was a decrease in its rheological values. The plastic viscosity and the yield point were both lowered with an increase in temperature. Rheological values for each temperature were lower upon the temperature reversal, but showed increasing stability at as the fluid was cooled from 120° C. to 60° C.

### Example 12

### Rheology and API Fluid Loss Measurements of Fluids Prepared with KCl and Microalgal Biomass

In this example, water-based fluids comprising spent Prototheca moriformis (UTEX 1435) biomass of Example 8 were evaluated for rheological properties and fluid loss control. Sample fluid compositions A-F were each prepared by mixing the following: 350 mL water, 2% KCl (w/v), 0.15% xanthan gum (w/v), and the percentage (w/v) of dried, spent microalgal biomass, ranging from 0.3% to 4% as indicated in Table 13. Samples were brought to a final pH of 8.0-9.0.

Rheology measurements for each sample, made using a FANN® Model 35 viscometer at the rpm indicated, are presented in Table 13. Plastic viscosity and yield point calculations were determined from the viscometer readings. Gel strength for each sample, presented in Table 13, was measured at 3 rpm after a 10 second and a 10 minute incubation period. Each sample was also subjected to the API fluid loss test at ambient temperature. For each sample, the volume of fluid passing through the filter after 7.5 minutes and 30 minutes is reported in Table 13.

TABLE 13
Rheology measurements, gel strength, and fluid loss measurements
performed on water-based fluids comprising microalgal biomass

| | | Fluid Sample | | | | | |
|---|---|---|---|---|---|---|---|
| | | A | B | C | D | E | F |
| microalgal biomass (% w/v) | | 0.3 | 0.44 | 1 | 2 | 3 | 4 |
| 600 rpm | | 48 | 54 | 58 | 65 | 85 | 110 |
| 300 rpm | | 37 | 36 | 39 | 49 | 61 | 75 |
| 200 rpm | | 32 | 30 | 33 | 39 | 49 | 60 |
| 100 rpm | | 24 | 25 | 26 | 27 | 36 | 45 |
| 6 rpm | | 8 | 8 | 8 | 9 | 11 | 15 |
| 3 rpm | | 6 | 6 | 6 | 7 | 9 | 12 |
| Pv (cP) | | 11 | 18 | 19 | 16 | 24 | 35 |
| YP (lb/100 sq ft) | | 26 | 18 | 20 | 33 | 37 | 40 |
| 10 sec gel (lb/100 sq ft) | | 8 | 9 | 9 | 9 | 11 | 14 |
| 10 min gel (lb/100 sq ft) | | 10 | 11 | 9 | 9 | 12 | 15 |
| API Fluid Loss | 7.5 min | 29 | 20 | 10.8 | 5.5 | 4 | 5.5 |
| | 30 min | 36 | 27 | 19 | 9 | 7.5 | 8.5 |

The plastic viscosity and the yield point of the prepared fluids increased with an increase in the amount of added microalgal biomass.

The gel strength of the prepared fluids increased with an increase in the percent amount of added microalgal biomass. Both the 10 second and 10 minute gel strength readings were greater for fluids comprising 3% or 4% biomass than for fluids comprising lower amounts of biomass. Whereas increasing the biomass in the prepared fluids resulted in an increase in gel strength after 10 second and 10 minute incubation periods, for a given concentration of biomass, the gel strengths of the 10 second and 10 minute gels were relatively unchanged.

Fluid loss showed a decreasing trend with an increasing concentration of spent microalgal biomass. A decrease in fluid loss was observed with an increase in the amount of microalgal biomass added to the fluid. The data presented in Table 13 demonstrate that spent microalgal biomass increases fluid viscosity and gel strength and improves fluid loss control.

### Example 13

### Rheology and API Fluid Loss Studies of Water-Based Fluids Prepared With Microalgal Biomass and Oil Field Chemicals

In this example, water-based fluids comprising spent Prototheca moriformis (UTEX 1435) biomass of Example 8 and different oil field chemicals were examined for viscosity, gel strength, and fluid loss control. Sample fluid compositions A-N were each prepared by mixing 350 mL water, 2% KCl (w/v), the type and percent concentration (w/v) of oil field chemical indicated in Table 15, and the percent concentration (w/v) of dried, spent microalgal biomass indicated in Table 14. Oil field chemicals tested in this example were hydroxyethylcelluose (HEC), xanthan gum (XG), polyacrylamide (PA), guar gum, carboxymethylcellose (CMC) with a low degree of substitution (LDS-CMC), high degree of substitution CMC(HDS-CMC), and bentonite. Samples were brought to a final pH of 8.0-9.0.

Rheology measurements for each sample, measured using a FANN® Model 35 viscometer at the rpm indicated, are presented in Table 15. Plastic viscosity and yield point calculations were determined from the viscometer readings. Gel strength, presented in Table 15, was measured at 3 rpm after 10 second and 10 minute incubation periods. Each sample was also subjected to the API fluid loss test at ambient temperature (20-25° C.). For each sample A-N, the volume of fluid passing through the filter after 7.5 minutes and 30 minutes is indicated in Table 15, below.

TABLE 14
Percentage (w/v) of microalgal biomass used in water-based fluids

| | Percent Biomass (w/v) in |
|---|---|
| Sample | fluid |
| A, C, E, G, I, K, M | 0.4 |
| B, D, F, H, J, L, N | 4.0 |

TABLE 15
Rheology profiles, gel strength, and API Fluid Loss measurements of
Water-based fluids prepared with microalgal biomass and oil field chemicals

| | Oil Field | | | | | | | | | 10 sec | 10 min | API Fluid | |
|---|---|---|---|---|---|---|---|---|---|---|---|---|---|
| | Chemical | rpm | | | | | | Pv | YP | gel | gel | Loss | |
| Sample | (w/v) | 600 | 300 | 200 | 100 | 6 | 3 | cP | lb/100 sq ft | | | 7.5 min | 30 min |
| A | 0.3% | 23 | 16 | 14 | 9 | 4 | 3 | 7 | 9 | 3 | 6 | 80 | 100 |
| B | HEC | 260 | 183 | 145 | 97 | 15 | 9 | 77 | 106 | 11 | 12 | 53 | 58 |
| C | 0.3% | 50 | 28 | 21 | 14 | 3 | 3 | 22 | 6 | 5 | 11 | 9.5 | 17.5 |
| D | XG | 161 | 112 | 92 | 67 | 24 | 20 | 49 | 63 | 20 | 27 | 4.5 | 7 |
| E | 0.3% | 64 | 39 | 30 | 19 | 4 | 3 | 25 | 14 | 9 | 6 | 28.5 | 247 |
| F | PA | 72 | 40 | 29 | 16 | 4 | 3 | 32 | 12 | 5 | 5 | 9 | 13 |
| G | 0.3% | 90 | 52 | 40 | 23 | 5 | 3 | 42 | 10 | 6 | 9 | * | * |
| H | Guar | 150 | 90 | 67 | 37 | 5 | 2 | 60 | 30 | 8 | 12 | 4.5 | 7 |
| | gum | | | | | | | | | | | | |
| I | 0.3% | 42 | 23 | 16 | 10 | 3 | 3 | 19 | 4 | 4 | 5 | 16 | 23 |
| J | LDS- | 77 | 42 | 30 | 17 | 4 | 3 | 35 | 7 | 4 | 5 | 4.5 | 7.5 |
| | CMC | | | | | | | | | | | | |
| K | 0.3% | 98 | 62 | 48 | 30 | 5 | 4 | 36 | 26 | 6 | 5 | 99 | 106.5 |
| L | HDS- | 139 | 86 | 64 | 39 | 6 | 4 | 53 | 33 | 5 | 6 | 8 | 10.5 |
| | CMC | | | | | | | | | | | | |
| M | 1.5% | 48 | 34 | 31 | 24 | 16 | 12 | 14 | 20 | 14 | 21 | 44 | 85 |
| N | Pre- | 55 | 36 | 31 | 23 | 14 | 13 | 19 | 17 | 10 | 12 | 9 | 22 |
| | hydrate | | | | | | | | | | | | |
| | bentonite | | | | | | | | | | | | |

The increased addition of microalgal biomass to water-based fluids increased the plastic viscosity of fluids comprising the oil field chemicals tested. The increased addition of microalgal biomass to water-based fluids increased yield point of water-based fluids prepared with HEC, XG, guar gum, LDS-CMC, or HDS-CMC. A >10 fold increase in Pv and YP was observed in water-based fluid comprising HEC as a result of increasing the concentration of microalgal biomass from 0.4% to 4%. A >10 fold increase in YP was observed for water-based fluid comprising xanthum gum as a result of increasing the concentration of microalgal biomass from 0.4% to 4%. A 3 fold increase in YP was observed for water-based fluid comprising guar gum as a result of increasing the concentration of microalgal biomass from 0.4% to 4%. A decrease in YP was observed for water-based fluid comprising PA or bentonite as a result of increasing the concentration of microalgal biomass from 0.4% to 4%. There was no effect of an increase in microalgal biomass on the gel strength of water-based fluid comprising LDS-CMC or HDS-CMC.

The increased addition of microalgal biomass to water-based fluids increased the gel strength of fluids prepared with HEC, XG, and guar gum. A 2 fold or greater increase in gel strength was exhibited by water-based fluids comprising HEC or XG as a result of increasing the concentration of microalgal biomass from 0.4% to 4%. A 33% increase in gel strength was exhibited by water-based fluids comprising guar gum as a result of increasing the concentration of microalgal biomass from 0.4% to 4%. The result of an increase in the concentration of microalgal biomass from 0.4% to 4% in to water-based fluids comprising either PA or bentonite was a decrease in gel strength.

The increased addition of microalgal biomass to water-based fluids increased the fluid loss control of fluids comprising the oil field chemicals tested by the API Fluid Loss test. After 30 minutes, a >10 fold decrease in fluid loss was observed for water-based fluid comprising PA or HDS-CMC as a result of increasing the concentration of microalgal biomass from 0.4% to 4%. The result of increasing the concentration of microalgal biomass from 0.4% to 4% on the fluid loss control of water-based fluids comprising guar gum was a near complete stoppage of fluid loss. For Sample G, comprising guar gum and 0.4% spent microalgal biomass, all tested fluid passed through the filter in less than 6 minutes (as indicated in Table 15 by a (*)). Sample H, comprising guar gum and 4.0% spent microalgal biomass, exhibited a fluid loss of only 4.5 ml and 7.0 ml after 7.5 minutes and 30 minutes, respectively.

These data demonstrate that addition of spent microalgal biomass improved the fluid loss control and decreased the fluid loss of water-based fluids comprising oil field chemicals. Further, these data indicate the utility of using microalgal biomass as fluid loss control additive in drilling fluids.

### Example 14

### Rheology and API Fluid Loss Studies of Water-Based Fluids Prepared With Microalgal Biomass and Oil Field Chemicals

In this example, water-based fluids comprising spent Prototheca moriformis (UTEX 1435) biomass of Example 8 and different oil field chemicals were examined for viscosity, gel strength, and fluid loss control. Sample fluid compositions A-S were each prepared by mixing 350 mL water, 2% KCl (w/v), the type and percent (w/v) of oil field chemical indicated in Table 16, and the percent (w/v) of dried, spent microalgal biomass indicated in Table 16. Oil field chemicals tested in this example were xanthan gum (XG), polyacrylamide (PA), polyanionic cellose (PAC), starch, and bentonite. Samples were brought to a final pH of 8.0-9.0.

Rheology measurements for each sample, measured using a FANN® Model 35 viscometer at the rpm indicated, are presented in Table 17. Plastic viscosity and yield point calculations were determined from the viscometer readings. Gel strength, presented in Table 17, was measured at 3 rpm after 10 second and 10 minute incubation period. Each sample was also subjected to the API fluid loss test at ambient temperature (20-25° C.). For each sample A-S, the volume of fluid passing through the filter after 7.5 minutes and 30 minutes is indicated in Table 17, below.

TABLE 16
Percent (w/v) of microalgal biomass and oil field chemicals used
in water-based fluids

| | % w/v | | | | | |
|---|---|---|---|---|---|---|
| | spent | | | | | |
| | microalgal | % w/v | % w/v | % w/v | % w/v | % w/v |
| Sample | biomass | PA | PAC | Bentonite | Starch | XG |
| A | 0.75 | 0.20 | 0.40 | 1.60 | 0.60 | 0.20 |
| B | 0.75 | 2.00 | 0.40 | 1.60 | 0.20 | 0.10 |
| C | 0.75 | 0.20 | 0.10 | 1.60 | 0.20 | 0.10 |
| D | 0.75 | 2.00 | 0.10 | 1.60 | 0.60 | 0.20 |
| E | 0.75 | 0.20 | 0.10 | 0.08 | 0.20 | 0.20 |
| F | 0.75 | 0.20 | 0.40 | 0.08 | 0.60 | 0.10 |
| G | 0.75 | 2.00 | 0.40 | 0.08 | 0.20 | 0.20 |
| H | 0.75 | 2.00 | 0.10 | 0.08 | 0.60 | 0.10 |
| I | 1.50 | 1.10 | 0.25 | 0.12 | 0.40 | 0.15 |
| J | 1.50 | 1.10 | 0.25 | 0.12 | 0.40 | 0.15 |
| K | 1.50 | 1.10 | 0.25 | 0.12 | 0.40 | 0.15 |
| L | 2.25 | 2.00 | 0.10 | 1.60 | 0.20 | 0.20 |
| M | 2.25 | 0.20 | 0.10 | 1.60 | 0.60 | 0.10 |
| N | 2.25 | 2.00 | 0.40 | 1.60 | 0.60 | 0.10 |
| O | 2.25 | 0.20 | 0.40 | 1.60 | 0.20 | 0.20 |
| P | 2.25 | 0.20 | 0.10 | 0.08 | 0.60 | 0.20 |
| Q | 2.25 | 2.00 | 0.10 | 0.08 | 0.20 | 0.10 |
| R | 2.25 | 2.00 | 0.40 | 0.08 | 0.60 | 0.20 |
| S | 2.25 | 0.20 | 0.40 | 0.08 | 0.20 | 0.10 |

TABLE 17
Rheology profiles, gel strength, and API Fluid Loss
measurements of Water-based fluids prepared with microalgal biomass and oil field

| | | | | | | | | | Gel Strength | | API Fluid | |
|---|---|---|---|---|---|---|---|---|---|---|---|---|
| | rpm | | | | | | Pv | YP | 10 sec | 10 min | Loss | |
| Sample | 600 | 300 | 200 | 100 | 6 | 3 | (cP) | lb/100 sq ft | | | 7.5 min | 30 min |
| A | 120 | 79 | 64 | 47 | 14 | 11 | 41 | 38 | 11 | 21 | 2 | 5.5 |
| B | 269 | 213 | 186 | 150 | 50 | 36 | 56 | 157 | 34 | 36 | 3.5 | 6 |
| C | 81 | 45 | 34 | 20 | 5 | 3 | 36 | 9 | 4 | 7 | 3.3 | 7.3 |
| D | 231 | 203 | 183 | 145 | 54 | 42 | 28 | 175 | 40 | 41 | 5 | 8 |
| E | 25 | 18 | 15 | 10 | 3 | 2 | 7 | 11 | 4 | 7 | 13 | 17.5 |
| F | 56 | 40 | 32 | 22 | 4 | 3 | 16 | 24 | 4 | 7 | 24 | 30 |
| G | 236 | 189 | 166 | 135 | 50 | 37 | 47 | 142 | 38 | 39 | 34.5 | 38 |
| H | 175 | 137 | 120 | 95 | 31 | 24 | 38 | 99 | 23 | 25 | 60 | 70 |
| I | 126 | 90 | 74 | 51 | 9 | 6 | 36 | 54 | 6 | 6 | 11.5 | 15.5 |
| J | 125 | 97 | 80 | 59 | 9 | 4 | 28 | 69 | 7 | 7 | 16.5 | 17.5 |
| K | 110 | 70 | 57 | 39 | 8 | 5 | 40 | 30 | 4 | 5 | 17 | 19 |
| L | 237 | 186 | 164 | 132 | 54 | 41 | 51 | 135 | 40 | 45 | 1.5 | 4 |
| M | 59 | 42 | 33 | 23 | 5 | 4 | 17 | 25 | 4 | 5 | 1.5 | 4.5 |
| N | 292 | 227 | 194 | 148 | 36 | 23 | 65 | 162 | 24 | 30 | 3 | 5 |
| O | 113 | 79 | 64 | 45 | 10 | 7 | 34 | 45 | 7 | 12 | 3.5 | 6.5 |
| P | 39 | 25 | 20 | 13 | 3 | 1 | 14 | 11 | 6 | 3 | 6.5 | 9.5 |
| Q | 186 | 166 | 155 | 121 | 52 | 41 | 20 | 146 | 41 | 42 | 11.5 | 15 |
| R | 247 | 196 | 172 | 140 | 49 | 35 | 51 | 145 | 34 | 37 | 11.5 | 15 |
| S | 67 | 45 | 37 | 26 | 4 | 2 | 22 | 23 | 2 | 2 | 20.5 | 24 |

### Example 15

### Temperature Effects on the Rheological Properties and Fluid Loss of Water-Based Fluid Prepared with Microalgal Biomass and an Oxygen Scavenger

In this example, the effect of temperature on the rheology and fluid loss control properties of a water-based fluid comprising spent Prototheca moriformis (UTEX 1435) biomass of Example 8 and an oxygen scavenger was examined. The fluid was prepared by mixing 350 mL water, 2% KCl (w/v), 0.15% xanthan gum (w/v), 4% (w/v) of dried, spent microalgal biomass, and 75 ppm oxygen scavenger. The fluid was adjusted to a final pH of 8.0-9.0. The ambient temperature rheology profile, gel strength, and fluid loss properties of the fluid before and after a 30 minute 120° C. heat treatment are presented in Table 18.

TABLE 18
The impact of heat treatment on the rheology profile, gel strength, and API fluid loss properties
of water-based fluid prepared with spent microalgal biomass and an oxygen scavenger

| | | | | | | | | | 10 sec | 10 min | API Fluid | |
|---|---|---|---|---|---|---|---|---|---|---|---|---|
| Test | | | | | | | Pv | YP | gel | gel | Loss | |
| Conditions | 600 rpm | 300 rpm | 200 rpm | 100 rpm | 6 rpm | 3 rpm | cP | lb/100 sq ft | | | 7.5 min | 30 min |
| Before | 155 | 115 | 96 | 73 | 29 | 22 | 40 | 75 | 19 | 23 | 1.8 | 4.5 |
| heating | | | | | | | | | | | | |
| After | 147 | 107 | 89 | 67 | 24 | 19 | 40 | 67 | 21 | 26 | 2.4 | 5 |
| cooling | | | | | | | | | | | | |

The result of a 30 minute 120° C. heat treatment on the rheology profile of the fluid was a minor decrease in viscosity. However, the plastic viscosity of the fluid was unaffected. The heat-treated fluid maintained 89% of its yield point. The fluid gel strength increased upon the heat treatment. Fluid loss properties were not appreciably changed as a result of the heat treatment. These data indicate that the ambient temperature rheology, gel strength, and fluid loss properties of a fluid prepared with 4% spent microalgal biomass and 75 ppm oxygen scavenger are stable upon 120° C. heat exposure.

### Example 16

### Fluid Loss Properties of Water-Based Fluids Comprising Various Amounts Of Spent Microalgal Biomass

In this example, water-based fluids comprising spent Prototheca moriformis biomass of Example 8 and xanthum gum were examined for fluid loss control properties at 120° F. (48.9° C.). Sample fluid compositions A-H were each prepared by mixing in water the type and percent (w/v) of brine salt indicated in Table 19, the percent (w/v) spent microalgal biomass indicated in Table 19, and 0.15% w/v xanthan gum. Kelco Xanvis® xanthum gum was used in the preparation of fluids described in this example. Upon mixing, fluids were aged for 16 hours at the temperature indicated in Tables 19, 20, and 21, then subjected to static fluid loss analysis. Static fluid loss tests were conducted on ceramic discs of pore size 5, 10, or 20 microns. Ceramic discs were pre-weighed and brine-soaked prior to use. Fluid loss tests were performed at 120° F. and 100-psi differential pressure for 1 hour or until maximum fluid loss was reached. Spurt loss, that fluid that passed through the ceramic disc upon initial application of the fluid, as well as total fluid loss, that fluid that passed through the ceramic disc after 1 hour, were reported in milliliters. Measurements of filter cake weight, spurt loss, and total fluid loss are presented in Table 20, Table 21, and Table 22.

TABLE 19
Type and Percent (w/v) of Materials added to water-based fluids

| | Brine | Brine | | Final Micoalgal Biomass |
|---|---|---|---|---|
| Sample | Type | Concentration | | Percentage (w/v) in fluid |
| A | KCl | 3% | w/v | 0 |
| B | KCl | 3% | w/v | 2 |
| C | NaCl | 9.0 | ppg | 0 |
| D | NaCl | 9.0 | ppg | 1 |
| E | NaCl | 9.0 | ppg | 2 |
| F | NaBr | 10.5 | ppg | 0 |
| G | NaBr | 10.5 | ppg | 1 |
| H | NaBr | 10.5 | ppg | 2 |

TABLE 20
Effect of Aging Temperature on the fluid loss properties of
water-based fluids comprising KCl and various percentages
of spent microalgal biomass

| | | | Ceramic Disc Pore Size | | |
|---|---|---|---|---|---|
| | Aging | | (microns) | | |
| Sample | Temperature ° F. | Test | 5 | 10 | 20 |
| A | 120 | Filter cake | 0.34 | 0.3 | 0.29 |
| B | | Weight (g) | 0.75 | 0.82 | 1.14 |
| A | | Spurt Loss | | | |
| B | | (mL) | 4.9 | 9.6 | 38.2 |
| A | | Total Fluid | 88 | 88 | 88 |
| B | | Loss (mL) | 14.9 | 19.4 | 56.9 |
| B | 175 | Filter cake | 0.65 | 0.75 | 0.83 |
| B | 225 | Weight (g) | 0.61 | 0.71 | 0.63 |
| B | 275 | | 0.63 | 0.63 | 0.56 |
| B | 325 | | 0.82 | 0.62 | 0.51 |
| B | 175 | Spurt Loss | 8.9 | 28.5 | 56 |
| B | 225 | (mL) | 12.5 | 35.8 | |
| B | 275 | | 17.4 | | |
| B | 325 | | | | |
| B | 175 | Total Fluid | 12.8 | 32.9 | 88 |
| B | 225 | Loss (mL) | 17.8 | 42.9 | 88 |
| B | 275 | | 88 | 88 | 88 |
| B | 325 | | 88 | 88 | 88 |

As shown in Table 20, fluids comprising spent oleaginous microalgal biomass were characterized by an increase in filter cake weight and a decrease in total fluid loss when subjected to a static filter test relative to fluids lacking oleaginous microalgal biomass. When aged at 120° F., Sample B (which comprised 2% w/v spent microalgal biomass) exhibited a >5 fold decrease in fluid loss over a 5 micron filter and a >3 fold decrease in fluid loss over a 10 micron filter relative to Sample A (lacking spent microalgal biomass).

TABLE 21
Fluid loss properties of water-based fluids comprising NaCl and
various percentages of spent microalgal

| | | | Ceramic Disc Pore Size | | |
|---|---|---|---|---|---|
| | Aging | | (microns) | | |
| Sample | Temperature ° F. | Test | 5 | 10 | 20 |
| C | 120 | Filter cake | 1.13 | 0.97 | 2.01 |
| D | 120 | Weight | 1.28 | 1.31 | 1.39 |
| E | 120 | (g) | 1.45 | 1.44 | 1.78 |
| C | 120 | Spurt Loss | | | |
| D | 120 | (mL) | 10.4 | 26.9 | 40 |
| E | 120 | | 6.9 | 13.8 | 40 |
| C | 120 | Total | 88 | 88 | 88 |
| D | 120 | Fluid Loss | 18.3 | 43.2 | 88 |
| E | 120 | (mL) | 12.5 | 20.5 | 80 |

As shown in Table 21, fluids comprising spent oleaginous microalgal biomass were characterized by an increase in filter cake weight, a decrease spurt loss, and a decrease in total fluid loss when subjected to a static filter test relative to fluids lacking oleaginous microalgal biomass. When aged at 120° F., Sample E (which comprised 2% w/v spent microalgal biomass respectively) exhibited a >7 fold decrease in fluid loss over a 5 micron filter and a >3 fold decrease in fluid loss over a 10 micron filter relative to Sample C (lacking spent microalgal biomass) aged at 120° F. Sample D, comprising 1% (w/v) spent oleaginous microalgal biomass, exhibited intermediate spurt loss and total fluid loss values when subjected to the static filter test using a 5 micron and a 10 micron pore size ceramic filter.

TABLE 22
Fluid loss properties of water-based fluids comprising NaBr and
various percentages of spent microalgal biomass

| | | | Ceramic Disc Pore Size | | |
|---|---|---|---|---|---|
| | Aging | | (microns) | | |
| Sample | Temperature ° F. | Test | 5 | 10 | 20 |
| F | 120 | Filter cake | 2.79 | 2.34 | 2.58 |
| G | 120 | Weight (g) | 2.83 | 2.71 | 2.83 |
| H | 120 | | 2.84 | 2.85 | 3.15 |
| F | 120 | Spurt Loss | 45.4 | | |
| G | 120 | (mL) | 12 | 28 | 57.5 |
| H | 120 | | 7.7 | 14.4 | 46.1 |
| F | 120 | Total Fluid | 61.7 | 88 | 88 |
| G | 120 | Loss (mL) | 16.6 | 33 | 88 |
| H | 120 | | 11.7 | 18.4 | 57.1 |

As shown in Table 22, fluids comprising spent oleaginous microalgal biomass were characterized by an increase in filter cake weight, a decrease spurt loss, and a decrease in total fluid loss when subjected to a static filter test relative to fluids lacking oleaginous microalgal biomass. When aged at 120° F., Sample H (which comprised 2% w/v spent microalgal biomass respectively) exhibited a >5 fold decrease in fluid loss over a 5 micron filter and a >4 fold decrease in fluid loss over a 10 micron filter relative to Sample F (lacking spent microalgal biomass) aged at 120° F. Sample G, comprising 1% (w/v) spent oleaginous microalgal biomass, exhibited intermediate spurt loss and total fluid loss values when subjected to the static filter test using a 5 micron pore size ceramic filter.

These data demonstrate the addition of spent microbial biomass to decrease the fluid loss and spurt loss of fluids comprising an oil field chemical.

### Example 17

### Rheological Properties of Water-Based Fluids Comprising Various Percentages of Spent Microalgal Biomass

In this example, water-based fluids comprising spent Prototheca moriformis (UTEX 1435) biomass of Example 8, xanthum gum, and salts were examined for rheological properties at 120 F (48.9 C). Sample fluid compositions A-H were each prepared by mixing in water the type and percent (w/v) of brine salt indicated in Table 19 (see Example 16), the percent (w/v) spent microalgal biomass indicated in Table 19, and 0.15% xanthan gum. Kelco Xanvis® xanthum gum was used in the preparation of fluids described in this example. Upon mixing, fluids were heated to 120° F. then analyzed for rheological properties using a Chandler 3500LS viscometer. Fluids were aged for 16 hours at the temperature indicated in Tables 23, 24, and 25, then again subjected to rheology measurements. Tables 23, 24, and 25 list the results of these rheological tests.

TABLE 23
Effect of Aging Temperature on the rheological properties of
water-based fluids comprising KCl and various percentages of spent microalgal biomass

| | | | | | | | Calculated Viscosity | | |
|---|---|---|---|---|---|---|---|---|---|
| | | Aging | | | | | (cP) | | |
| Sample | Condition | Temp. ° F. | n′ | K(ind) | K′slot | R2 | 1 sec⁻¹ | 10 sec⁻¹ | 100 sec⁻¹ |
| A | Before Aging | | 0.435 | 0.0033 | 0.0039 | 0.985 | 187 | 51 | 14 |
| A | After Aging | 120 | 0.457 | 0.0032 | 0.0037 | 0.986 | 177 | 51 | 15 |
| A | After Aging | 175 | 0.474 | 0.0031 | 0.0036 | 0.966 | 172 | 51 | 15 |
| A | After Aging | 225 | 0.148 | 0.0021 | 0.0025 | 0.611 | 118 | 17 | 2 |
| A | After Aging | 275 | 0.395 | 0.001 | 0.0012 | 0.982 | 58 | 14 | 4 |
| A | After Aging | 325 | 0.368 | 0.0011 | 0.0013 | 0.938 | 61 | 14 | 3 |
| B | Before Aging | | 0.435 | 0.0033 | 0.0039 | 0.985 | 187 | 51 | 14 |
| B | After Aging | 120 | 0.491 | 0.0032 | 0.0037 | 0.99 | 179 | 55 | 17 |
| B | After Aging | 175 | 0.371 | 0.0059 | 0.007 | 0.976 | 334 | 78 | 18 |
| B | After Aging | 225 | 0.441 | 0.0031 | 0.0036 | 0.984 | 171 | 47 | 13 |
| B | After Aging | 275 | 0.125 | 0.0025 | 0.0029 | 0.622 | 140 | 19 | 2 |
| B | After Aging | 325 | 0.125 | 0.0035 | 0.0041 | 0.626 | 197 | 26 | 3 |

As shown in Table 23, Sample B, comprising 2% w/v spent oleaginous microalgal biomass, relative to Sample A that lacked oleaginous microalgal biomass, was characterized by an increase in calculated viscosity, measured at a shear rate of 1 sec⁻¹, 10 sec⁻¹, and 100 sec⁻¹, as aging temperature was increased from 120° F. to 325° F. In addition, Sample B, relative to Sample A was characterized by a decrease in the flow behavior index (n′) as aging temperature was increased from 120° F. to 325° F.

TABLE 24
Rheological properties of water-based fluids comprising NaCl
and various percentages of spent microalgal biomass

| | | | | | | | Calculated | | |
|---|---|---|---|---|---|---|---|---|---|
| | | | | | | | Viscosity | | |
| | | Aging | | | | | (cP) | | |
| Sample | Condition | Temp. ° F. | n′ | K(ind) | K′slot | R2 | 1 sec⁻¹ | 10 sec⁻¹ | 100 sec⁻¹ |
| C | Before | | 0.428 | 0.002 | 0.0024 | 0.934 | 113 | 30 | 8 |
| | Aging | | | | | | | | |
| C | After | 120 | 0.586 | 0.0012 | 0.0013 | 0.953 | 64 | 25 | 10 |
| | Aging | | | | | | | | |
| D | Before | | 0.375 | 0.0032 | 0.0038 | 0.91 | 180 | 43 | 10 |
| | Aging | | | | | | | | |
| D | After | 120 | 0.461 | 0.0026 | 0.0031 | 0.959 | 148 | 43 | 12 |
| | Aging | | | | | | | | |
| E | Before | | 0.463 | 0.0032 | 0.0037 | 0.985 | 178 | 52 | 15 |
| | Aging | | | | | | | | |
| E | After | 120 | 0.464 | 0.0035 | 0.0041 | 0.982 | 196 | 57 | 17 |
| | Aging | | | | | | | | |

As shown in Table 24, fluids comprising spent oleaginous microalgal biomass, relative to a control fluid that lacked oleaginous microalgal biomass, were characterized by an increase in calculated viscosity, measured at a shear rate of 1 sec⁻¹, 10 sec⁻¹, and 100 sec⁻¹. Upon aging at 120° F., Sample E, comprising 2% w/v spent oleaginous microalgal biomass was characterized by an increase in calculated viscosity measured at a shear rate of 1 sec⁻¹, 10 sec⁻¹, and 100 sec⁻¹, whereas Sample C, upon aging at 120° F. exhibited decreased calculated viscosities at all shear rates tested.

TABLE 25
Rheological properties of water-based fluids comprising NaBr
and various percentages of spent microalgal biomass

| | | | | | | | Calculated | | |
|---|---|---|---|---|---|---|---|---|---|
| | | | | | | | Viscosity | | |
| | | Aging | | | | | (cP) | | |
| Sample | Condition | Temp. ° F. | n′ | K(ind) | K′slot | R2 | 1 sec⁻¹ | 10 sec⁻¹ | 100 sec⁻¹ |
| F | Before | | 0.44 | 0.0021 | 0.0024 | 0.948 | 116 | 32 | 9 |
| | Aging | | | | | | | | |
| F | After | 120 | 0.477 | 0.002 | 0.0023 | 0.97 | 112 | 33 | 10 |
| | Aging | | | | | | | | |
| G | Before | | 0.49 | 0.0022 | 0.0026 | 0.966 | 122 | 38 | 12 |
| | Aging | | | | | | | | |
| G | After | 120 | 0.445 | 0.0034 | 0.004 | 0.98 | 192 | 53 | 15 |
| | Aging | | | | | | | | |
| H | Before | | 0.456 | 0.0034 | 0.0039 | 0.987 | 187 | 53 | 15 |
| | Aging | | | | | | | | |
| H | After | 120 | 0.436 | 0.0042 | 0.005 | 0.985 | 238 | 65 | 18 |
| | Aging | | | | | | | | |

As shown in Table 25, fluids comprising spent oleaginous microalgal biomass, relative to a control fluid that lacked oleaginous microalgal biomass, were characterized by an increase in calculated viscosity, measured at a shear rate of 1 sec⁻¹, 10 sec⁻¹, and 100 sec⁻¹. Upon aging at 120° F., Samples G and H, comprising 1% and 2% w/v spent oleaginous microalgal biomass, respectfully, were characterized by an increase in calculated viscosity measured at a shear rate of 1 sec⁻¹, 10 sec⁻¹, and 100 sec⁻¹, whereas Sample F, upon aging at 120° F., exhibited decreased calculated viscosity at a shear rate of 1 sec⁻¹.

It is understood that the examples and embodiments described herein are for illustrative purposes only and that various modifications or changes in light thereof will be suggested to persons skilled in the art and are to be included within the spirit and purview of this application and scope of the appended claims.

1. A fluid for use in the creation or maintenance of, or production from, a borehole or well, the fluid comprising biomass from an oleaginous microbe.

2. The fluid of claim 1, wherein the biomass functions as a bridging agent, a fluid loss control agent, a viscosity modifier, an emulsifier, a lubricant, or a density modifier.

3. The fluid of claim 1, wherein the fluid comprises an aqueous or non-aqueous solvent and optionally comprises one or more additional components so that the fluid is operable as a drilling fluid, a drill-in fluid, a workover fluid, a spotting fluid, a cementing fluid, a reservoir fluid, a production fluid, a hydraulic fracturing fluid, or a completion fluid.

4. The fluid of claim 1, wherein the oleaginous microbe is selected from the group consisting of microalgae, yeast, fungi, and bacteria.

5. The fluid of claim 1, wherein the microbial biomass comprises intact cells, lysed cells, a combination of intact and lysed cells, cells from which oil has been removed, or polysaccharide from the oleaginous microbe.

6. The fluid of claim 1, wherein the microbial biomass is chemically modified.

7. The fluid of claim 6, wherein the chemical modification comprises covalent attachment of hydrophobic, hydrophilic, anionic, and cationic moieties.

8. The fluid of claim 7 wherein the microbial biomass is chemically modified through one or more chemical reactions selected from the group consisting of transesterification, saponification, crosslinking, anionization, acetylation, and hydrolysis.

9. The fluid of claim 8, wherein the anionization is carboxymethylation.

10. The fluid of claim 1, wherein the microbial biomass is approximately 0.1% to approximately 20% by weight of the fluid.

11. The fluid of claim 1, the fluid further comprising one or more additives selected from the group consisting of bentonite, xanthan gum, guar gum, starch, carboxymethylcellulose, hydroxyethyl cellulose, polyanionic cellulose, biocide, a pH adjusting agent, an oxygen scavenger, a foamer, a demulsifier, a corrosion inhibitor, a clay control agent, a dispersant, a flocculant, a friction reducer, a bridging agent, a lubricant, a viscosifier, a salt, a surfactant, an acid, a fluid loss control additive, a gas, an emulsifier, a density modifier, diesel fuel, and an aphron.

12. The fluid of claim 11 wherein the fluid comprises an aphron having an average diameter of 5 to 50 micrometers at a concentration of about 0.001% to 5% by mass of the fluid.

13. The fluid of claim 1, wherein the biomass results from one or more of drying, pressing, and solvent-extracting oil from the oleaginous microbe.

14. The fluid of claim 1, wherein the biomass is produced by the heterotrophic growth of the oleaginous microbe.

15. The fluid of claim 14, wherein the oleaginous microbe is an obligate heterotroph.

16. The fluid of claim 15, wherein the oleaginous microbe is Prototheca moriformis.

17. The fluid of claim 1, wherein the fluid has a decrease in API Fluid loss test as compared to fluid lacking the biomass.

18. A fluid of claim 1, wherein the fluid is characterized by a reduction of fluid loss of greater than 2, 5, or 10 fold relative to a control fluid lacking oleaginous microbial biomass according to the API Fluid Loss test for a duration of either 7.5 or 30 minutes.

19. The fluid of claim 1, wherein the fluid is characterized by a 2 fold, 5 fold, 10 fold or greater increase in yield point relative to a control fluid lacking oleaginous microbial biomass as measured using a Couette type viscometer.

20. The fluid of claim 1, wherein the fluid is characterized by an at least 2 fold decrease in spurt loss volume relative to a control fluid lacking oleaginous microbial biomass as measured according to a static fluid loss test performed with a ceramic disc filter.

21. The fluid of claim 1, wherein the fluid is characterized by an at least 2 fold decrease in total fluid loss volume relative to a control fluid lacking oleaginous microbial biomass as measured according to a static fluid loss test performed with a ceramic disc.

22. The fluid of claim 20, wherein the static fluid loss test is performed with a ceramic disc having a pore size selected from the group consisting of 5 microns, 10 microns, and 20 microns.

23. The fluid of claim 21, wherein the total fluid loss is measured after a duration of 30 minutes or 60 minutes.

24. The fluid of claim 1, wherein the fluid is characterized by an at least 2 fold increase in gel strength relative to a control fluid lacking oleaginous microbial biomass according to a gel strength test performed with a Couette type viscometer.

25. The fluid of claim 24 wherein the gel strength test is performed for one of durations selected from 7.5 minutes and 30 minutes.

26. The fluid of claim 1, wherein the fluid is characterized by a higher calculated viscosity after aging at a temperature of between 18° C. and 200° C. for at least 16 hours, than prior to aging, when measured at a shear rate between 0.01/sec and 1000/sec.

27. A method for creating a wellbore, or maintaining, or producing a production fluid from a well, the method comprising introducing a fluid according to claim 1.

28. The method of claim 27, comprising using the fluid to for a well servicing operation selected from the group consisting of: completion operations, sand control operations, workover operations, and hydraulic fracturing operations.

29. The method of claim 27, comprising drilling a wellbore through a formation by operating a drilling assembly to drill a wellbore while circulating a drilling fluid through the wellbore.

30. A method of claim 27, wherein the biomass occludes pores in the wellbore or well.

31. A method of claim 29, wherein the biomass provides lubrication to a drill bit of the drilling assembly.

32. A method of claim 28, wherein the biomass increases the viscosity of the fluid.

33. A method for stimulating the production of methane from methanogenic microbes in a well comprising introducing biomass produced by cultivating an oleaginous microbe into the well.
